(19) United States
(12) Patent Application Publication
(10) Pub. No.: US 2023/0337608 A1
(43) Pub. Date: Oct. 26, 2023

(54) NUTRIENT RELEASE FOR HYDROPONIC GROWING SYSTEM

(71) Applicant: Rise Gardens Inc., Skokie, IL (US)

(72) Inventors: Henry W. Adams, Evanston, IL (US); Angelo E. Kelvakis, Chicago, IL (US); Brandon C. Bay, Chicago, IL (US); Diego Alonso Blondet Padro, Miami, FL (US); Yan Kwok, Chicago, IL (US); Lamija Memidzan, Evanston, IL (US)

(73) Assignee: Rise Gardens Inc., Skokie, IL (US)

(21) Appl. No.: 18/302,592

(22) Filed: Apr. 18, 2023

Related U.S. Application Data
(60) Provisional application No. 63/333,765, filed on Apr. 22, 2022.

(51) Int. Cl. A01G 31/02; A01C 23/04

(52) U.S. Cl. CPC A01G 31/02; A01C 23/042; A01G 2031/006

(57) ABSTRACT

The apparatus for providing nutrients to plants in a hydroponic plant growing system contains a nutrient release capsule and a capsule holder. The nutrient release capsule is a sustained release nutrient product comprising a hydroponic plant fertilizer center with a biopolymer outer coating to slow the release of the nutrients into the liquid (e.g., water). The capsule holder consists of a modifiable structure that can exist in multiple configurations to deliver different release dosage behaviors into and in response to the liquid for the hydroponic plant fertilizer.

### CLAIM OF PRIORITY

This application claims priority to U.S. Provisional Patent Application No. 63/333,765, entitled “NUTRIENT RELEASE CAPSULE”, filed Apr. 22, 2022 by Adams et al., which is incorporated by reference herein in its entirety.

### BACKGROUND

Plants need certain nutrients in order to grow and be healthy. Plant nutrients typically are divided into macronutrients and micronutrients. The macronutrients are sometimes divided into primary macronutrients and secondary macronutrients. Examples of primary macronutrients include nitrogen, phosphorus, and potassium. Examples of secondary macronutrients include sulfur, calcium, and magnesium. Examples of micronutrients include iron, molybdenum, boron, copper, manganese, sodium, zinc, nickel, chlorine, cobalt, aluminum, silicon, vanadium, and selenium. When plants are grown in soil, the soil provides many, if not all, of the needed nutrients. In some cases, fertilizer may be added to the soil to provide nutrients. Plants also need oxygen and hydrogen, which may be provided by air and/or water.

Hydroponics is a method of growing plants without the use of soil. A hydroponic plant growing system may use water containing plant nutrients to facilitate plant growth. Herein, the plants nutrients that are delivered in water may also be referred to as hydroponic nutrients. It can be challenging to provide sufficient nutrients to plants in a hydroponic plant growing system.

### BRIEF DESCRIPTION OF THE DRAWINGS

Aspects of the present disclosure are illustrated by way of example and are not limited by the accompanying figures for which like references indicate elements.

FIG. 1 is a high-level diagram of an embodiment for some of the elements of a hydroponic system.

FIGS. 2A-2D present views of the hydroponic system of FIG. 1 incorporated into a rack or cabinet.

FIGS. 3A and 3B respectively illustrate a 3-level embodiment and a single layer embodiment for a hydroponic system.

FIGS. 4A and 4B respectively show a top and bottom view of the housing, including the covering lids on top and a light source mounted on the bottom.

FIG. 4C shows an underlying tray, including an elbow for receiving an upper level's drainpipe.

FIGS. 5A-5C show a cross-section taken transversely across FIG. 4A, where FIGS. 5B and 5C are detail of FIG. 5A.

FIGS. 6A and 6B illustrate the structure of an embodiment for the tray, where FIG. 6B is a detail of FIG. 6A.

FIGS. 6C and 6D illustrate the use of the region of the conduit and auxiliary drain opening for supplying the tray and providing overflow protection for a top level tray and a lower level tray, respectively.

FIGS. 7A and 7B are bottom views of the tray embodiment of FIG. 6A.

FIGS. 8A-8C illustrates an embodiment of a net cup for holding a plant as part of a hydroponic system.

FIG. 9 illustrates an embodiment of the hydroponic system with plants in place.

FIG. 10 is a diagram of an environment in which embodiments may be practiced.

FIG. 11 is table that defines example conditions and nutrient needs of various types of plants that might be grown in a hydroponic system.

FIG. 12 is a flowchart of one embodiment of a process of providing a water profile for plants grown in a hydroponic system.

FIG. 13 is a flowchart of one embodiment of a process of providing a water profile for plants grown in a hydroponic system.

FIG. 14 is a flowchart of one embodiment of a process of adjusting a water profile for plants grown in a hydroponic system.

FIG. 15 is a flowchart of one embodiment of a process of determining an amount of nutrients to add to the hydroponic system.

FIG. 16 is a flowchart of one embodiment of a process of a ranking algorithm.

FIG. 17 is a flowchart of one embodiment of a process of pH correction for a hydroponic system.

FIG. 18 depicts a capsule holder.

FIG. 19 depicts a capsule.

FIG. 20 depicts a capsule holder positioned in a hydroponic plant growing system.

FIG. 21 is a graph of nutrient uptake versus time.

FIG. 22 depicts a capsule holder storing multiple capsules.

FIG. 23 depicts a tank and three positions for connecting a capsule holder to the tank.

FIG. 24 depicts a tank and three positions for connecting a capsule holder to the tank at different water levels.

FIG. 25A depicts a tank and a capsule holder comprising a vertically elongated post.

FIG. 25B depicts a tank and a capsule holder comprising a vertically elongated post.

FIG. 25C depicts the vertically elongated post.

FIG. 26 depicts a capsule holder comprising a body and a buoyant head.

FIG. 27 depicts a capsule holder in a tank with different water levels.

FIGS. 28A-C depict a top view of a capsule holder.

FIGS. 29A-C depict a side view of a capsule holder.

FIG. 30 is a flow chart describing one embodiment for operating the capsules and capsule holder discussed herein.

### DETAILED DESCRIPTION

The proposed apparatus for providing nutrients to plants in a hydroponic plant growing system contains a nutrient release capsule and a capsule holder. One embodiment of the nutrient release capsule is a sustained release nutrient product comprising a hydroponic plant fertilizer center with a biopolymer outer coating to slow the release of the nutrients into the liquid (e.g., water). One embodiment of the capsule holder comprises a modifiable structure that can exist in multiple configurations to deliver different release dosage behaviors into and in response to the liquid for the hydroponic plant fertilizer.

In some embodiments, the capsule holder consists of a modifiable enclosing that can exist in multiple states to deliver three (or more) different release dosage behaviors: modified release dosage, sustained release dosage, and diminishing release dosage. Two example structures for the capsule holder include one that engages the water (or other liquid) at various heights (the Ladder) and another with a floating mechanism with gates to let in different volumes of water (The Floating Gate). The user will fill up and configure their capsule holder with the one or more capsules in response to instructions from a software application as to which configuration/position inside the reservoir they should place/set their capsule holder (e.g., including what size opening to set). Once these are set in place, the nutrients will be slowly released over time so that the user can enjoy a semi-automated dosing of hydroponic nutrients to their hydroponic plant growing system. The user will be alerted to refill, or change the configuration of their capsule holder, based on the plants they are growing.

Some embodiments disclosed herein include or may be part of a continuous flow hydroponic system suitable for the indoor growing multiple crops/plants of different types at the same time. The hydroponic system can include a single layer or multiple layers of growing trays arranged over a pump. The pump directly supplies the top-most tray with water including from a tank, with each of the lower trays being supplied from drainpipe of the tray above. The bottom tray drains back to the tank.

A hydroponic system may re-circulate water that contains plant nutrients. The hydroponic system may contain multiple different types of plants (also referred to a crops), which may need different plant nutrients. The hydroponic system may potentially expose these multiple types of plants to the same water, and hence the same nutrients. It can be difficult for a user to determine suitable nutrients to add to the water in the hydroponic system in view of the wide range of nutrient needs of the various types of plants. This problem is made more difficult due to the possibility that plants may be in different growth stages, thereby affecting the nutrient needs. Embodiments disclosed herein determine suitable nutrients to add to a hydroponic system that recirculates water that is exposed to multiple types of plants that have different nutrient needs.

One embodiment disclosed herein includes a central controller that may determine suitable plant nutrients to add to a hydroponic system. The central controller may provide this information to numerous remote electronic devices (e.g., application on cellular phones) such that a user in control of the remote electronic device may learn what nutrients to add to their hydroponic system, including which capsules to add to the capsule holder and which configuration to implement for the capsule holder to obtain the appropriate release dosage behavior. In one embodiment, the central controller collects plant observations from the user of the hydroponic systems. These plant observations may include the amount of time that a certain type of plant to reach a specific growth stage. The central controller uses these plant observations to modify how the central controller determines what plant nutrients that the users should add to their respective hydroponic systems, and which configuration to implement for the capsule holder to obtain the appropriate release dosage behavior.

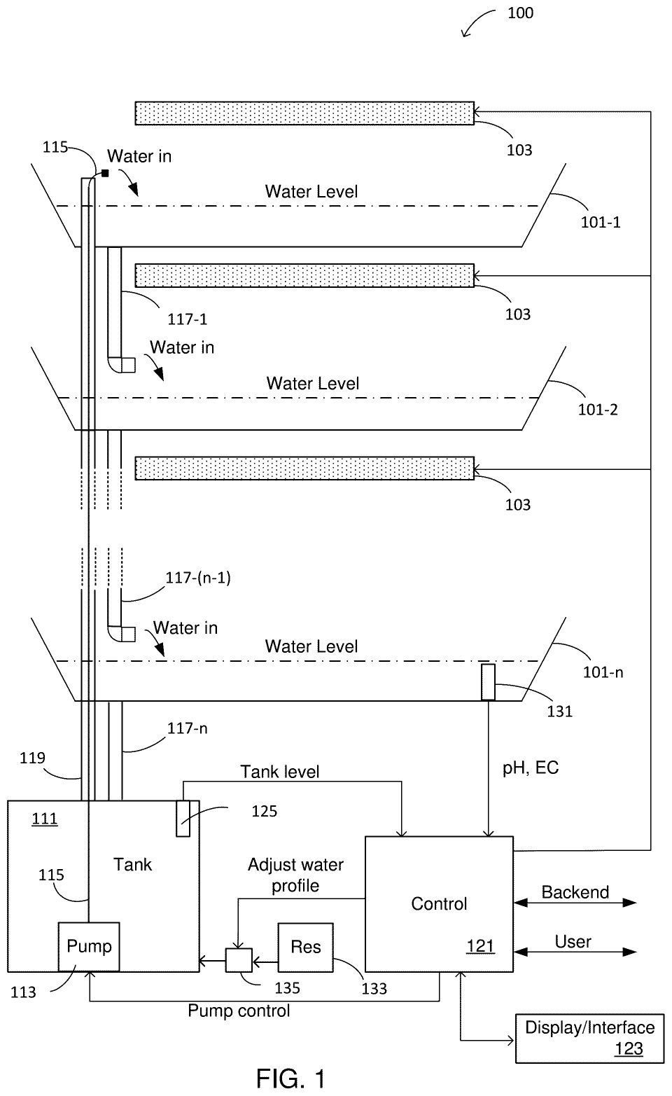

FIG. 1 is a high-level diagram of one embodiment of a hydroponic system 100. One or more trays 101 are arranged to each hold one or more plants suspended above a layer of water so that roots of the plants can absorb the water and nutrients in the water. The content of the water and nutrients, or “water profile,” can be chosen based upon the plants being grown and their stages of development. Above each tray a light source 103 can be provided over the tray. In an outdoor use, natural lighting can be used, but the light sources 103 can be used to augment or replace natural lighting in situations with insufficient natural lighting. The following will mainly consider embodiments for indoor usage and include a light source 103 above each tray 101.

To provide the water (e.g., aqueous hydroponic nutrient) to the trays, a water re-circulation system is used. The water re-circulation system can include a pump 113 to supply the water and plant nutrients from a water reservoir or tank 111. The pump 113 is connected to the water tank 111 to supply trays 101 and can supply one or more of the trays 101 directly or a tray can be supplied from another tray. In the embodiments mainly presented in the follow discussion, the trays 101 are arranged vertically so that the pump 113 will supply the top-most tray 101 directly, which will in turn supply a lower lying tray 101 in a gravity fed arrangement. For example, as illustrated in FIG. 1, a top-most tray 101-1 is fed directly, that will feed a lower tray 101-2, that will in turn feed a lower lying tray, and so on to the lowest lying tray 101-n. FIG. 1 shows the pump 113 feeding a series of multiple trays, but other embodiment may have only a single tray, in which case the lowest lying tray 101-n will be the only tray and fed directly from the 113. In other embodiments, a single water re-circulation system can feed more than one series of trays, each series having one or more trays and where the number of trays in the different series can differ.

In addition to the pump 113 and tank 111, the water re-circulation system includes the plumbing to deliver the water (e.g., aqueous hydroponic nutrient) from the tank to the trays 101 from the tank 111 and deliver the water back to the tank 111. In the multi-tray, gravity fed series arrangement illustrated in FIG. 1, the pump 113 supplies the top-most tray 101-1 from the tank 111 with a supply tube 115. For example, the supply tube 115 can be plastic or other flexible tubing, or PVC or metal piping. The following embodiments will mainly describe a flexible plastic tubing, as this is often convenient and easy to install. The diameter of the supply tube 115 can be chosen based upon the capability of the pump 113 and height of the tray 101-1 that it is supplying directly.

In the embodiment of FIG. 1, the supply tube 115 runs up though a pipe 119 that extends upward through the vertically arranged trays 101 to the top-most tray 101-1, serving as a conduit for the supply tube 115 and also as an auxiliary or overflow drainpipe. For this purpose, the conduit/auxiliary drainpipe 119 is arranged so that any of the water (e.g., aqueous hydroponic nutrient) that flows into conduit/auxiliary drainpipe 119 will flow back into the water tank 111. When the trays 101 are arranged vertically one over the other, the conduit/auxiliary drainpipe 119 can be a set of straight pipe sections, such as formed of PVC (polyvinyl chloride), stacked one above the other as a vertical column. In other embodiments, the supply tube 115 need not use the auxiliary drainpipe 119 as a conduit, in which case the pipe 119 may be eliminated; or the pipe 119 may serve only as a conduit for the supply tube 115, without serving as an auxiliary drain pipe for overflow protection; however, the following discussion will mainly refer to embodiments using a combined conduit and auxiliary drainpipe function for the pipe 119, as this can provide overflow protection as well as provide a convenient path from the pump 113 to the top-most tray 101-1. In the following, the pipe 119 will mainly be referred to as an auxiliary or overflow drainpipe.

Each tray 101 will have a (primary) drain opening to which is connected a drainpipe 117. For the lower-most tray 101-n, the corresponding drainpipe 117-n can drain directly back into the tank 111. For the higher trays, the drain pipe of each tray can supply the tray of the next lower level in a gravity fed series arrangement, so that, for example, the drainpipe 117-1 from tray 101-1 supplies tray 101-2 and the lower-most tray 101-1 can be supplied by the drain pipe 117-(n−1) of the preceding tray of the series. The drainpipes can again be made of PVC pipe sections, such as a straight pipe section that ends in an elbow when supplying an underlying tray. In a single layer embodiment with only one tray, the single tray would be supplied directly from supply tube 115 and then its drainpipe would flow directly back to the tank 111.

Embodiments of the hydroponic system 100 can include control circuitry 121 of varying levels of automation. For example, the control circuitry 121 can be connected for controlling the pump 113 and lighting elements 103. The system can also include a water level sensor 125 to monitor the level of water (e.g., aqueous hydroponic nutrient) in the tank 111. The system 100 can include a user display and interface 123 to provide user information, such as the water level in the tank 111, and receive inputs, such as to turn the lighting elements 103 or pump 113 on or off. Depending on the embodiment, the control circuitry can also communicate with a user over a wireless link to a smartphone, for example, or to back-end processing (e.g., central controller 1902) located remotely.

In some embodiments, the hydroponic system 100 can also include sensors 131 to monitor the water profile in one or more of the trays or the tank 111. For example, the sensors 131 can include a pH monitor and an electrical conductivity (EC) monitor in one of the trays that can be used to monitor the water profile by the control circuitry 121. In other embodiments, these values can alternately or additionally be determined manually. Based on the monitoring, the water profile can be adjusted manually or automatically by adding nutrients and pH agents. In some embodiments, based on the monitoring the control circuitry 121 can automatically adjust the water profile by use of pumps 135 connected to supply the tank 111 from reservoirs 133 for nutrients and pH agents. The control systems are discussed in more detail below, including the balancing of the water profile for the concurrently growing multiple crops of different types in the same hydroponic system 100.

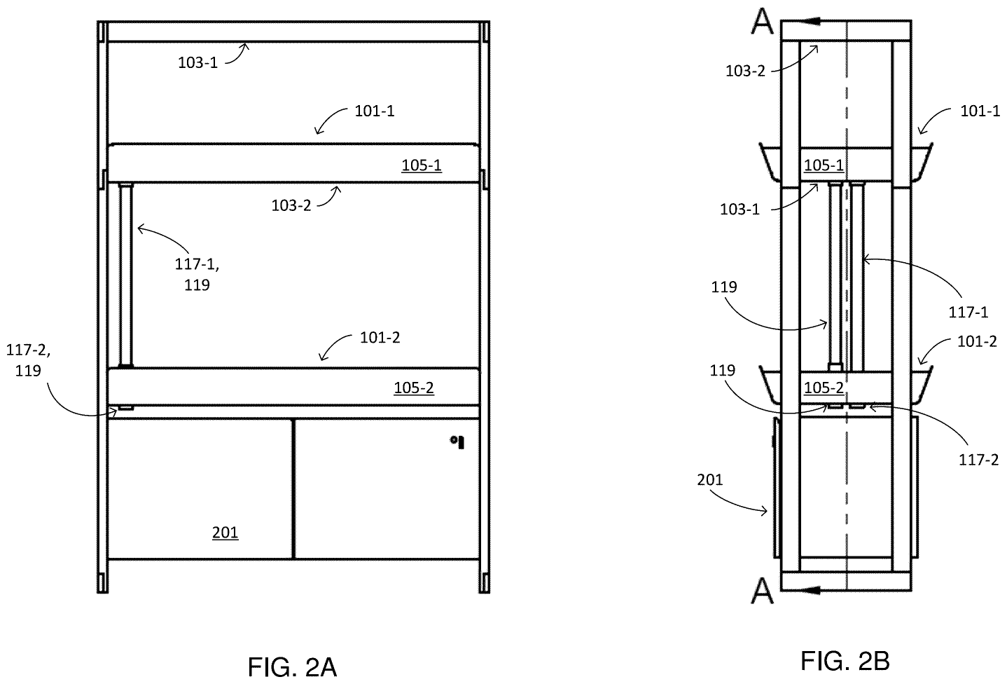

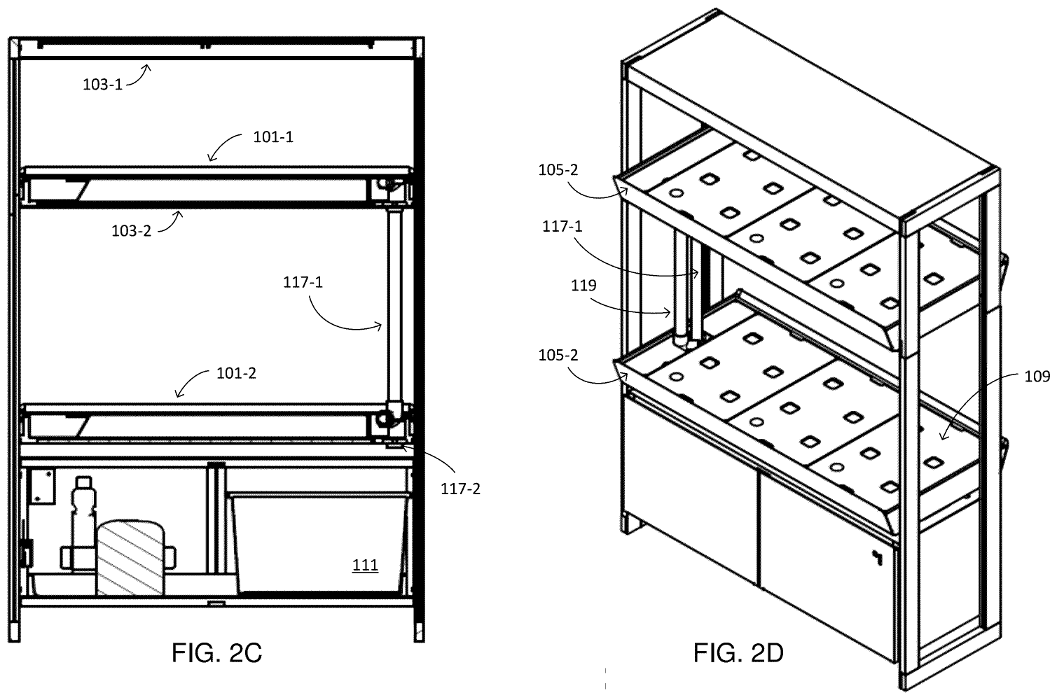

FIGS. 2A-2D present views of the hydroponic system 100 of FIG. 1 incorporated into a rack or cabinet for support. More specifically, FIGS. 2A-2D respectively present a front view, a side view, a cut-away rear view, and an oblique view of a 2-level hydroponic system, where the lower level of this double tray embodiment has a tall lower level and a short upper level. Such an arrangement could be used an indoor vegetable smart garden to grow a mixture of crops such as peppers, tomatoes, herbs, spices, and lettuces year-round.

In the front view FIG. 2A, the upper tray 101-1 is held in a housing 105-1 and illuminated from above by a light fixture 103-1. The lower tray 101-2 is held in a housing 105-2 and illuminated by a light fixture 103-2 that can be integrated into the housing 105-1. The power cord for the light 103-1 and 103-2 can run up the back side of the one of the support legs, for example. The upper tray 101-1 can be supplied by the water (e.g., aqueous hydroponic nutrient) by a supply tube running up the auxiliary drainpipe 119 from the water re-circulation system located in the cabinet section 201 of the support structure. The lower tray 101-2 is fed by the upper level drainpipe 117-1 and drains by the lower level drainpipe 117-2 into the tank located in the cabinet 201. The cabinet 201 can include doors for covering the water re-circulation system, control systems, and also be used for storage. In the arrangement of FIGS. 2A-2D, the trays are supplied and drained from the same side, such that in front view of FIG. 2A the one obstructs the other. For example, the drainpipes 117-1, 117-2 may located in front of the auxiliary drainpipe 119, or vice-versa.

By placing the supply and drain for the trays on the same end of the trays, they can both be placed over the tank, so that both the (primary) drainpipes 117-1, 117-2 and supply conduit and auxiliary drainpipe 119 can flow directly down into the supply tank 111 for both normal drainage and overflow drainage. Under this plumbing architecture, the water re-circulation system can be grouped to the one side (the left side in this example) of the cabinet 201, leaving the other side available for control elements and storage. In contrast, if the trays were fed from one end drained from the other, the plumbing components would be less compact and spread across both sides of the structure.

FIG. 2B is side view of the hydroponic system shown from the front in FIG. 2B. From the side view, both of the drainpipes 117-1, 117-2 and supply conduit and auxiliary drainpipe 119 can be seen. FIG. 2B shows a cut line at A-A, where the rear view of FIG. 2C is taken at this cut line.

In the cut-away rear view of FIG. 2C, a longitudinal cross-section of the trays 101-1 and 101-2 can be seen, as well as a cross-section of the light fixtures 103-1 and 103-2. In the example here, the drainpipes 117-1 and 117-2 are shown as they are in front of the A-A cut line. Inside of the cabinet is shown the tank 111, where the other objects shown can be various elements of the pump and control systems shown in FIG. 1 or other objects stored there.

FIG. 2D is an oblique view from the front and above of the hydroponic system 100 of FIG. 1 incorporated into a rack or cabinet. From above the top of the trays 101-1 and 101-2 can be seen to be covered by a set of removable lids 109 that can used to hold the plants. A number of different lid configurations can be used, both as far as the number of lids covering a tray and configuration of the lids. In the example of FIG. 2D, each tray is shown to be covered by three lids having cup openings, into which net cups can be placed for holding plants, along with a smaller lid along the left (as represented in the figure) edge that is a separate service cover for the drain and supply regions. As discussed in more detail below, a number of arrangements can be used for the removable lids 109. Although FIG. 2D shows holes for holding net cups that would be used for many crops, arrangements more suitable for root vegetables or microgreens are also discussed below.

The embodiment illustrated in FIGS. 2A-2D has two tray levels, but the hydroponic system of FIG. 1 has a modular structure allowing to the system to be configured, or reconfigured, to a greater or fewer number of number of layers. In multi-layer embodiments, the vertical spacing of the layers can be the same or different.

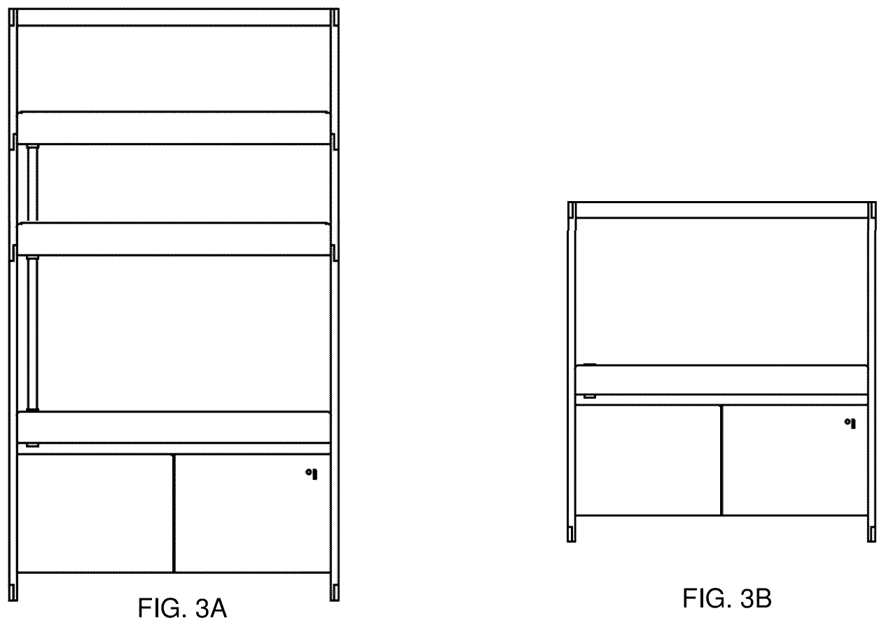

FIGS. 3A and 3B respectively illustrate a 3-level embodiment and a single layer embodiment for a hydroponic system. In the 3-level example of FIG. 3A, two short levels are arranged over a taller bottom layer. In a single layer embodiment such as FIG. 3B, the supply line directly feds the single tray, which can then directly drain back into the supply tank.

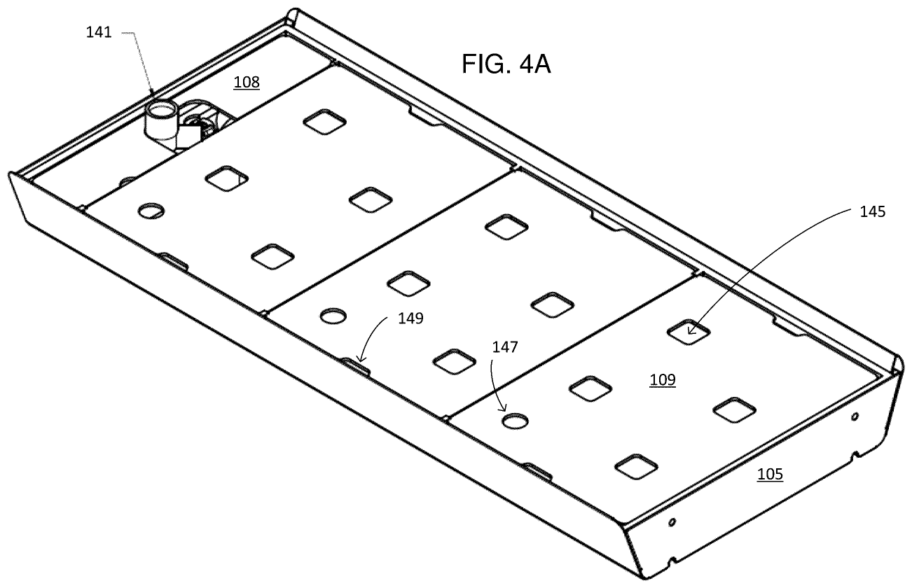

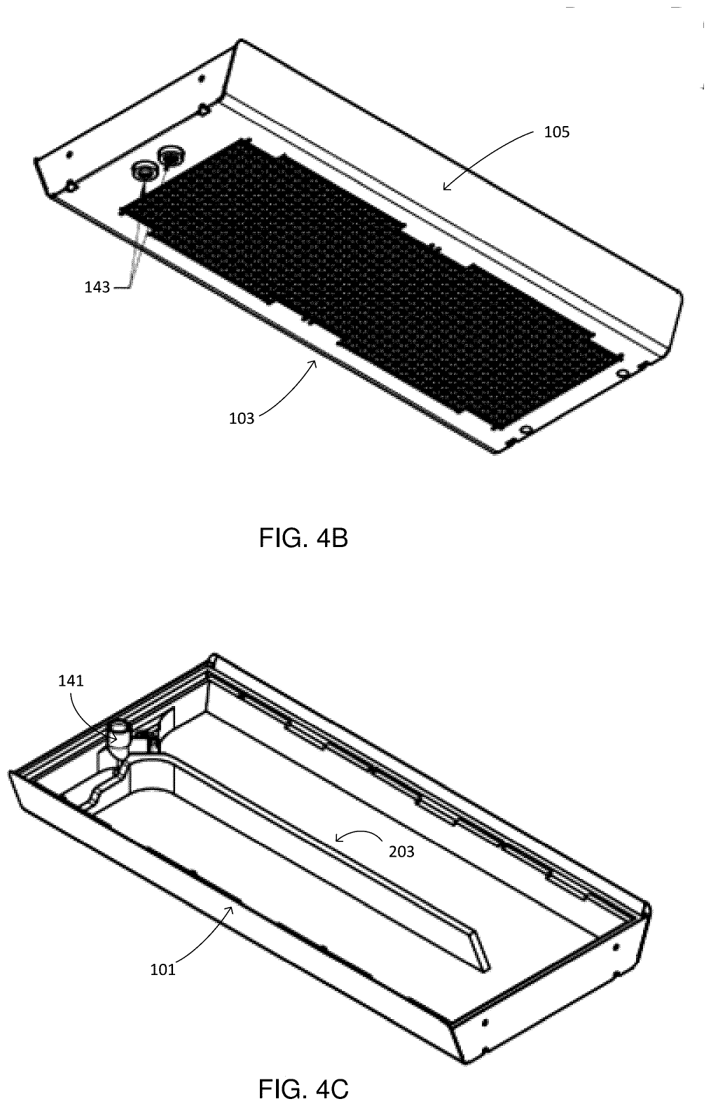

FIGS. 4A and 4B respectively show a top and bottom view of the housing, including the covering lids on top and a light source mounted on the bottom. FIG. 4C shows an underlying tray, including an elbow for receiving an upper level's drainpipe. The outer housing 105 serves as an external tray to support the tray 101 and attaches to the frame or rack to hold the trays in a vertical arrangement, such as is shown in FIGS. 2A-2D. In FIG. 4A, the underlying tray 101 is largely obscured, being covered by the tray lids 109 and the service lid or door 108. In the shown embodiment, the tray is covered by three lids 109, but other embodiments can use a lesser or greater number of lids 109. In the shown embodiment, each lid has four holes or cup openings, such as illustrated at 145, for holding a net cup that is configured to hold a net cup that can in turn hold a plant suspended above the underlying tray. Depending on the embodiment, differing numbers, arrangements and sizes of the cup openings 145 can be used. For example, the cup openings 145 may be lined up along the back of the tray 101, rather than staggered, to take advantage of a trellis along the back of the structure in the case of vining plants. In other variations, some of the cup openings 145 may be sized to hold a smaller cup for the growing of herbs, for example. One or more of the lids 109 can include an opening 147 for the insertion of a sensor or sensors, where these can be inserted by a user to manually test the pH, electrical conductivity, or other properties of the water profile, or hold sensors connected to the control systems to automatically monitor the water profile. The lids 109 can also include finger holes or openings 149 along the edges to make it easier to remove the lids 109.

Referring now to the bottom view of FIG. 4B, if the tray 101 is to be positioned above another tray 101, the lower surface of the housing 105 can include a light source 103. In one set of embodiments, the light source 103 can include a number of LEDs, such as a mix of white, red, and blue LEDs to provide spectral content suitable for plant growth. The intensity of the light source 103 may be fixed or adjustable in intensity, and the relative intensities of the different LED types may also be adjustable in some embodiments to allow the spectral content to be varied according to the plant selection, for example. The array of LEDs can be covered by a grid of baffles or louvers to direct the light downward and avoid light straying from the underlying tray 101 to where it could shine in the eyes of people or fade furniture and carpets, for example.

As also shown in FIGS. 4B, the underside of the housing 105 has a pair of openings 143 that could each have a female grommet fitting and a male slip fitting for the attachment of the tray's drainpipe 117 and auxiliary drainpipe 119. Referring again to the top view of FIG. 4A, the service door or lid 108 covers the end region of the tray 101 where the tray's drain and auxiliary drain openings are located, leaving an opening where the drainpipe and auxiliary drainpipe from the overlying layer attach. For example, an elbow 141 is shown that can include a female slip fitting to which a drainpipe for the above tray can be connected to supply water (e.g., aqueous hydroponic nutrient) to the tray 101 in the sort of gravity fed series arrangement of trays described above. FIG. 4C illustrates one embodiment for the tray 101 and location of the elbow 141 in the tray 101. The elbow 141 can be a PVC elbow, for example, and is positioned to direct the incoming water to the region above and to the right (as represented in FIG. 4C) of the lateral barrier running lengthwise in the rectangular tray 101. (The structure of the tray 101 is discussed in more detail below.)

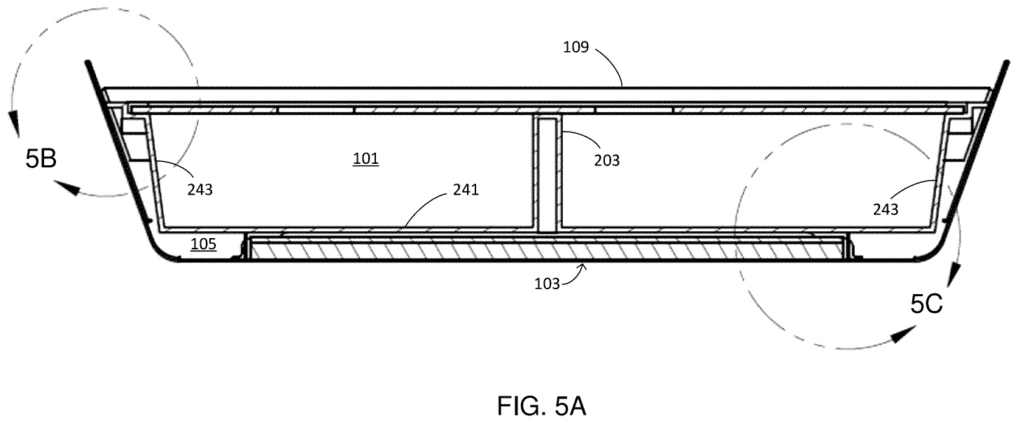

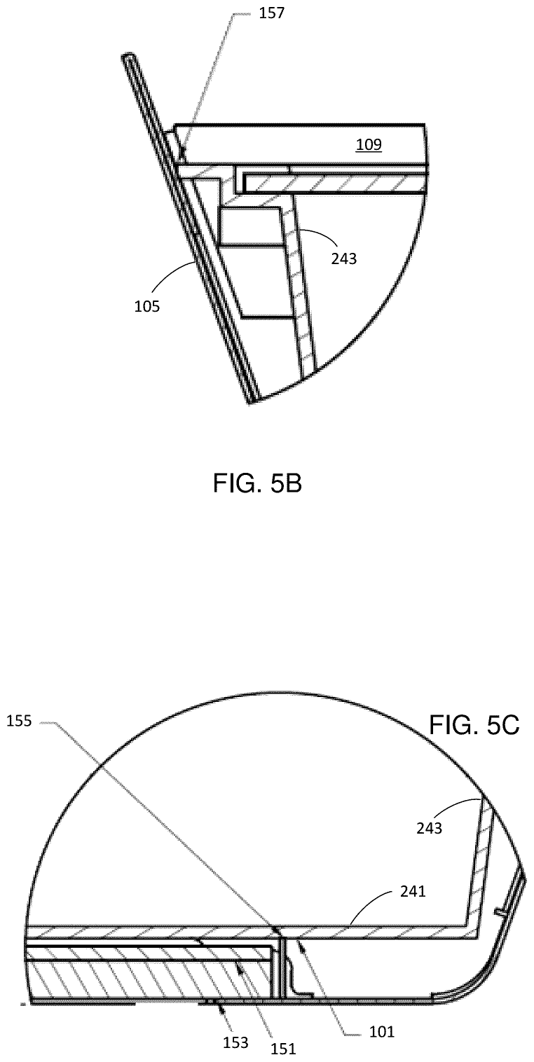

FIGS. 5A-5C show a cross-section taken transversely (the short direction across the rectangular structure) of FIG. 4A, where FIGS. 5B and 5C are detail of FIG. 5A. The housing 105 forms an outer tray to hold the tray 101 for the aqueous hydroponic nutrient. The vertical element at the center is the lateral barrier 203 of the tray 101 and is discussed in more detail below. Over the top of the tray 101 is the lid 109, and recessed into the bottom of the housing 105 is the light source 103. In FIG. 5A the interior floor or bottom of the tray is indicated at 241 and can either be flat or slope from the input towards the drain. In the embodiments primarily discussed here, the floor 241 is flat and at the same level as the drain, so that the floor 241 is at the same height both to the left and to the right of the lateral barrier 203. In a sloping floor embodiment, the floor 241 on the side closer to the input (to the right of the lateral barrier 203 as represented in FIG. 5A) would be higher than the floor on the drain side (to the left). The walls 243 can either be sloped or vertical, depending on the embodiment. For example, in the embodiments illustrated in the figures here, the longer front and back side walls 243 seen in FIG. 5A both slope outwards, while the shorter side walls (not seen in the cross-section of FIG. 5A) are vertical.

The detail of FIG. 5B is an expanded view of the correspondingly marked region of FIG. 5A. The edge or lip of tray 101 is stepped for fitting into the supporting housing 105, being cut to fit closely to the housing, as indicated at 157.

The detail of FIG. 5C is an expanded view of the correspondingly marked region of FIG. 5A. As indicated at 155, the bottom of tray 101 can be supported by resting on vertical flanges of the housing 105. When the housing 105 includes a light fixture 103, the light fixture 103 can be recessed into the bottom of the housing 105. The light panel 151 can be formed of an array of LEDs recessed into the housing 105, which is covered with the louver 153 that can be flush with the bottom of the surrounding housing 105.

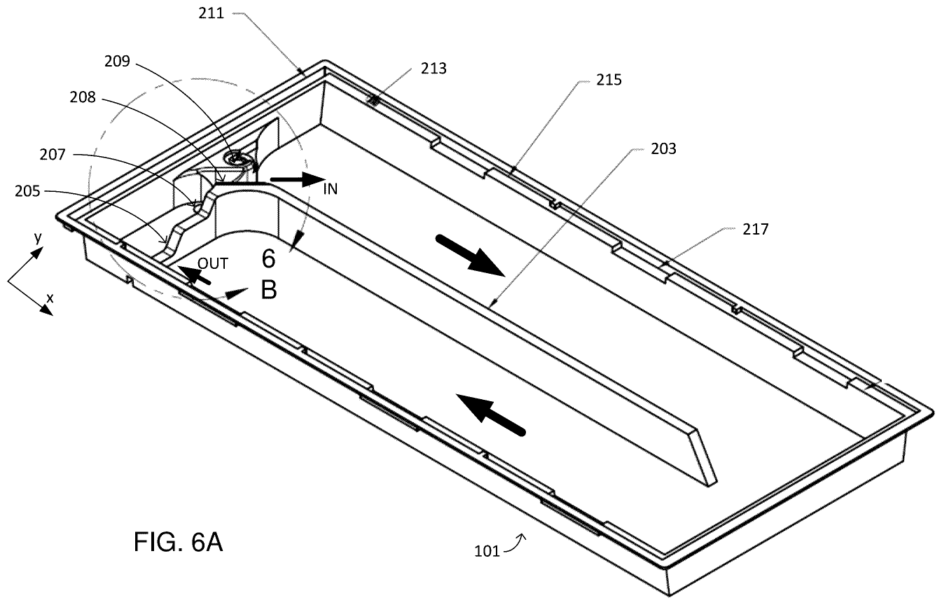

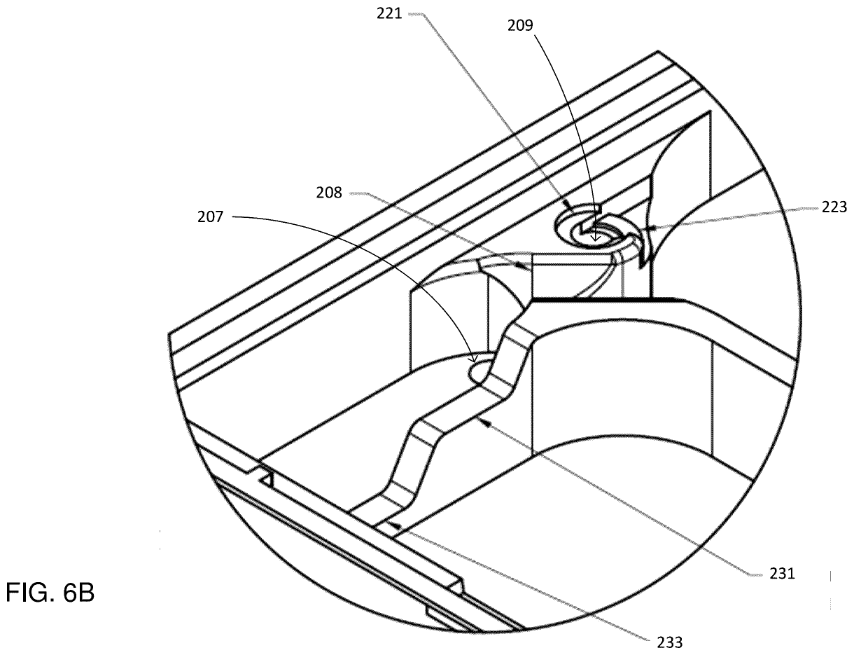

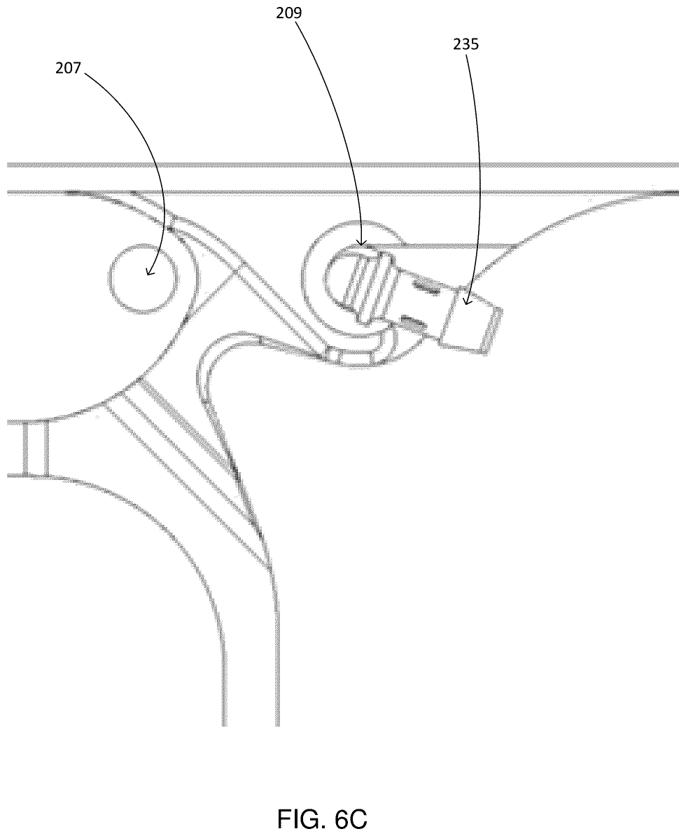

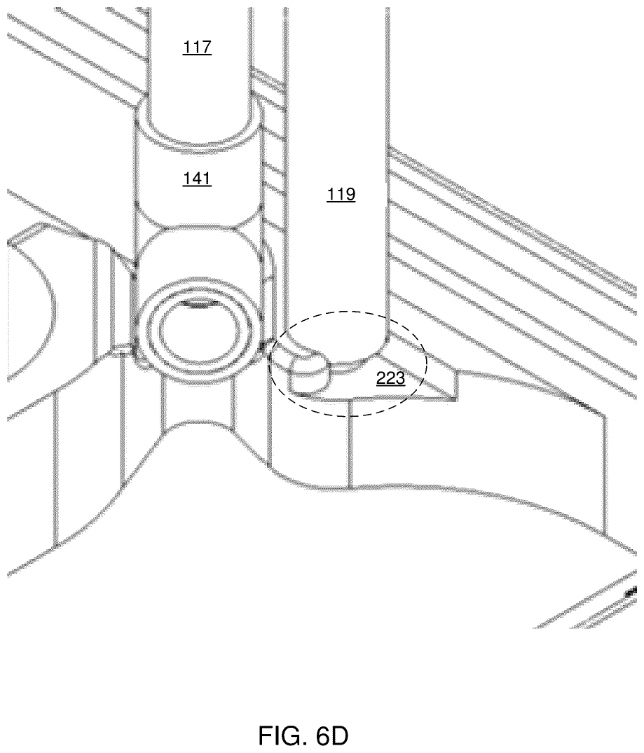

FIGS. 6A and 6B illustrate the structure of an embodiment for the tray 101, where FIG. 6B is a detail of FIG. 6A. In the embodiment of FIG. 6A, the tray 101 is a rectangular shape, extending the x, or lateral, direction for a length of several times the width in the y, or transverse, direction. Other shapes can be used for alternate embodiments, but the configuration of FIG. 6A is suited to the sort of rack or cabinet for indoor use that was described above with respect to FIGS. 2A-2D. The tray can be formed of molded plastic, such as thermoformed high impact polystyrene for example.

The water can be fed in (as marked by the IN arrow) by a supply tube (e.g., 115 of FIG. 1) at opening 209 for a top level, or single level embodiment, tray 101, or from a drainpipe from a higher level that would connect to an elbow (141 of FIG. 4A or 4C) that can rest in the curved recessed region 208 that can be shaped as a “half-pipe” area that is configured to hold the elbow. For either source, the input is provided from an area raised above the tray bottom, from which it will flow to one side of lateral barrier 203 running most of the length of the tray 101 in the x direction. The water will drain from the tray 101 at a drain opening 207 (mostly obscured in the FIG. 6A), flowing toward the drain (as indicated by the OUT arrow).

In the embodiments illustrated here in FIGS. 4C, 5A, 6A and related figures, the tray 101 has a rectangular shape with the longer front and back side walls running in the lateral direction sloping outward, and the shorter front and back side walls being vertical. The interior floor or bottom 241 is flat and at the same level as, or somewhat above, the drain opening 207, with the main portion of the floor (with the lateral barrier 203 and the region over which the plants are placed). The main region or portion of the floor 241, over which the plants are located and suspended in the net cups in the cup openings 145 of the lids 109, is separated from the dam region by the dam 205 with a lower region 233 that is raised relative to the main region or portion of the floor 241, but lower than the opening 209 and region 208 that are used for the input and auxiliary overflow. The opening 209 and region 208 that are used for the input and auxiliary overflow are in turn lower than the lateral barrier 203, so that any input of water from these elements will be directed to the input side. As noted, both of the drain opening 207 and the opening 209 and region 208 are located off to the same side of the tray relative to the main region or portion of the floor 241.

In a top (or single) level tray, the supply tube will enter at opening 209, while for lower levels an auxiliary drainpipe segment will attach at opening 209, extend upward to attach below the overlying tray and act as a conduit for the supply tube. From the drain opening 207, a drainpipe section is connected to return the water to the tank (for the bottom-most tray) or to supply an underlying tray. The drainpipe section extending from the drain hole of the overlying can be aligned with the drain opening 207, but fit into an elbow fitted into the region 208 so that it will be directed to the input side.

In FIG. 6A, both the input and the output for the water are located along the upper left (as represented in the figure) shorter side of the tray 101. As discussed above, this allows for the plumbing of the water re-circulation system to all be arranged along the one side for convenience. This means that the water to flow from the input to the drain opening and, so that all of the plants suspended over the tray 101 to be supplied, to flow across the full surface of the tray bottom. To direct the flow, a lateral barrier 203 can be included to provide the flow as indicated by the arrows. The lateral barrier can also serve a support function for the tray lids. In the embodiment of FIG. 6A, the lateral barrier separates the input region around opening 209 above and to the right (as represented in FIG. 6A from the drain region around opening 207, extending laterally most of the length of the tray 101, but with a gap at the end opposite the input and output regions. This allows the flow from the input to travel toward the far end of the tray 101 on the one end, loop around the end of the lateral barrier and flow back towards drain 207, covering the bottom of the tray. It will be understood that FIG. 6A is just particular embodiment and that, in addition to changes of relative dimensions, left-right, front-back, or both can be swapped around. The lateral barrier 203 can also have other shapes and provide more than two channels: for example, in the case of a square shape for the tray 101, the lateral barrier 203 could be formed of several sections to direct the flow from the input to the far end in a first channel toward the far, redirect the flow back to the input end in a second channel, redirect the flow back again toward the far end in a third channel, before finally directing it back to the dam 205 in a fourth channel.

To affect the flow along the tray 101 as illustrated by the arrows in FIG. 6A, the bottom of the tray 101 can be slopped downwards toward the drain opening 207, use a dam, or a combination of these. The embodiment of FIG. 6A uses a flat bottom and a dam 205. The dam 205 extends from the lateral barrier 203 to the side wall to limit the flow as indicated at the OUT arrow to the drain 207. The height of the dam 205 will set the water level in the tray 101. The use of a dam 205 to maintain a water depth in the tray 101 will make the flow less sensitive to how level the tray is within the supporting structure of a rack or frame for small angles.

FIG. 6B provides detail on the corresponding region circled in FIG. 6A, including the dam 205, drain opening 207, and the auxiliary drainpipe/input opening 209. The dam 205 includes a lower region 233 that acts as a weir and sets the water height in the tray 101, and a raised barrier region 231 that can inhibit root incursion into the area around the drain opening 207. The height of the lower dam region 233 can vary based upon the embodiment to allow for different water heights in the tray and can be of a fixed height, as shown in FIG. 6B, or user adjustable for allow for the water height to be user-set or allow for the tray 101 to be drained without its being removed.

In the embodiment of FIGS. 6A and 6B, the lateral barrier 203 curves around into the dam region 205, but in other examples, these could meet at a right angle or with a diagonal region. The curvature allows space for the “half-pipe” region 208 that is configured to locate the pipe elbow 141 as shown in FIG. 4C where the overlying tray's drainpipe can connect to supply the tray 101. FIG. 6B also shows detail for the opening 209. Around the opening 209, the tray can include an annular region of a recessed step as indicated at 221 that can locate and support an auxiliary drainpipe connected to the bottom of the overlying tray. Relative to the level of the recessed step as indicted at 221, a region 223 can be further stepped down. For the top-most tray, the stepped channel at 223 can hold an elbow or other end of the supply tube 115 so that it can provide the input flow of the water and plant nutrients provided by the water re-circulation system from the tank 111 as illustrated in FIG. 1. For lower level trays, which will have an auxiliary drainpipe mounted into the recessed step 221, this provides an overflow gap into which water can flow down the auxiliary drainpipe 119 to drain off an excessive water level and reduce the likelihood that a tray will overflow.

Considering the relative heights of the lower dam region 233, the raised barrier 231, and stepped channel 223 of the opening 209, the lower dam region 233 is the primary outflow channel from the tray 101 and acts as a weir to set the level of liquid in the tray 101. The stepped channel 223 is set higher than lower dam region 233 and provides overflow if the drain opening 207 becomes blocked or sufficiently obstructed (such as by roots, for example) so that it cannot keep up with the inflow rate, or if the lower dam region 233 is blocked. The raised barrier region 231 can be at an intermediate height between that of the stepped channel 223 and the lower dam region 233 and serve an alternate spillway-like function when the drain opening 207 is still draining, but the lower dam region 233 is obstructed.

FIGS. 6C and 6D illustrate the use of the region of the opening 209 for supplying the tray 101 and providing overflow protection for a top-level tray and a lower level tray, respectively. In the case of a top-level tray shown in FIG. 6C, the supply tube 115 of FIG. 1 runs up the conduit and auxiliary drainpipe 119 into the opening 209 and ends in an elbow or nozzle fitting 235 to feed the tray 101. The elbow or nozzle fitting 235 can be lodged in the stepped channel 223 to hold it in place, while still leaving room around sides in the opening 209 so that it can provide the overflow function if the drain opening 207 becomes obstructed. FIG. 6D shows the situation for a lower tray that is supplied by the drainpipe 117 from over-lying tray that ends the elbow 141. The auxiliary drainpipe 119 sits in (and obstructs the view of) the annular region of step 221 around the opening 209 of FIG. 6B, providing a conduit for the supply tube 115 going up to, and auxiliary drainage coming down from, the over-lying tray. The stepped channel 223 provides a gap (circled in the figure) for overflow drainage, where the gap provided by the step channel 223 can be augmented or replaced by cutting into the auxiliary drainpipe 119 for this purpose.

Returning to FIG. 6A, the edges of the tray 101 can include features to accommodate tray lids 109 and the service lid 108 as shown in FIG. 4A. A pocket indicated at 211 can allow the service lid 108 to rest vertically over the tray 101. A set of bumps, such as indicated at 213 can locate the tray lids 109 and the service lid 108 on the tray 101. The “shelves” along the side, such as indicated at 215, can support the tray lids 109 and the service lid 108 over the tray 101. In between the “shelf” segments along the edge of the tray 101 can be finger holes, such as indicated at 217 to facilitate lifting of the lids.

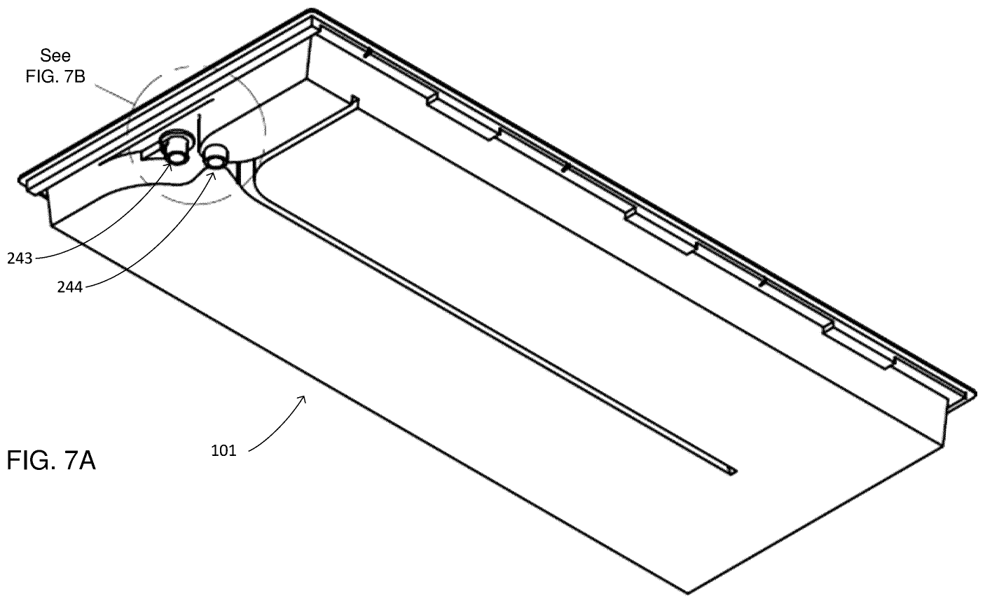

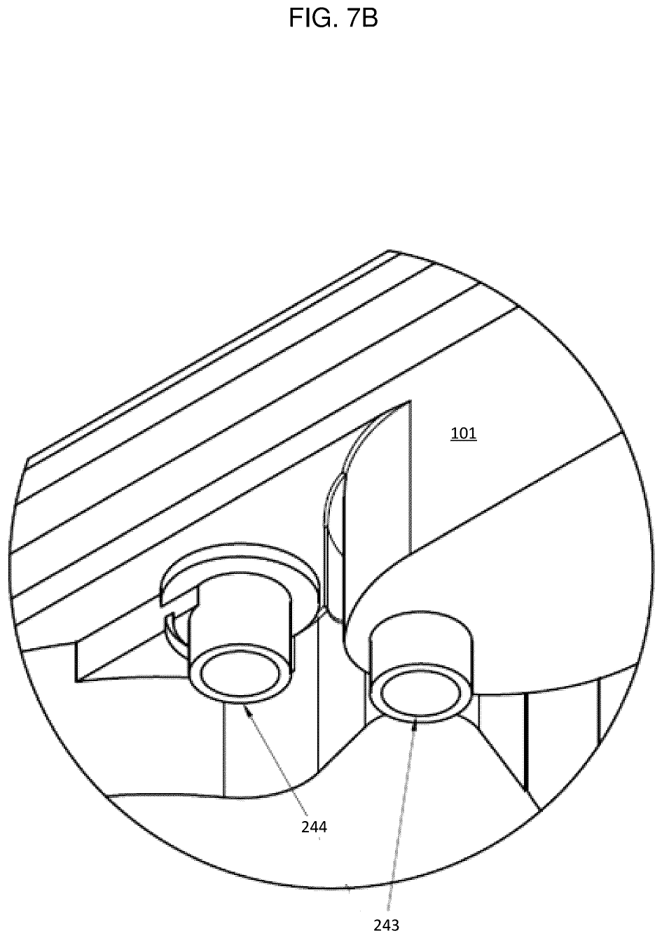

FIGS. 7A and 7B are bottom views of the tray embodiment of FIG. 6A. On the underside of tray 101 as shown in FIG. 7A, along the upper left edge, are a downspout 244 for connection of the (primary) drainpipe 117 and the auxiliary drainpipe 119. FIG. 7B is a detail showing the circled region of FIG. 7A.

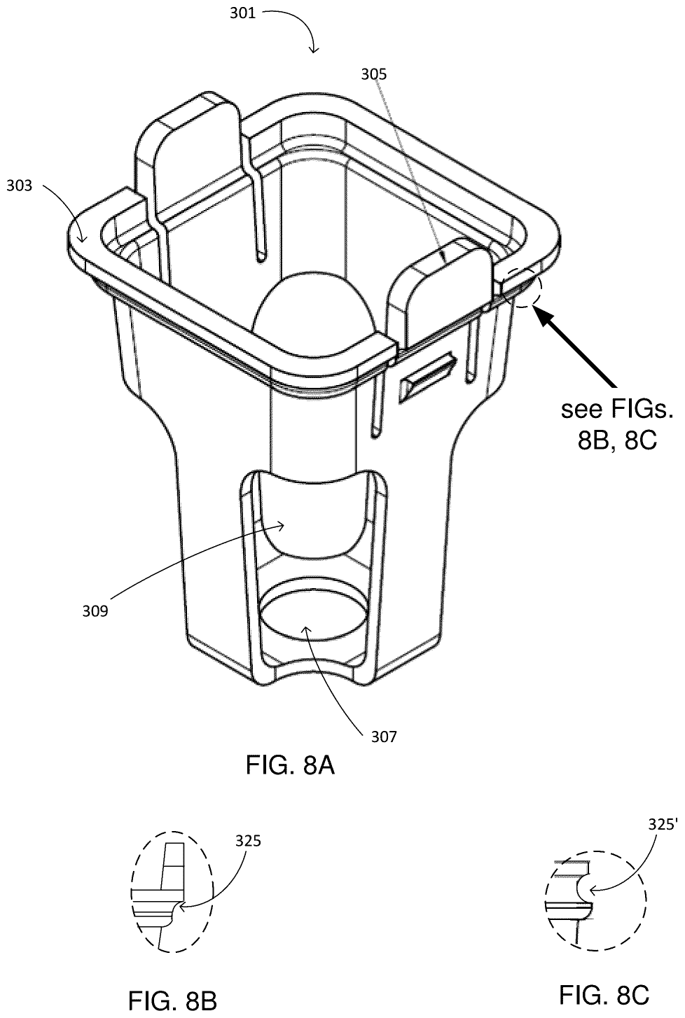

Referring back to FIGS. 2D and 4A, the trays 101 of the hydroponic system 100 are covered by lids 109 having cup openings 145 that are configured for holding net cups that hold the plants. FIG. 8A shows one example of a net cup.

FIG. 8A illustrates an embodiment of a net cup 301 for holding a plant as part of a hydroponic system. The net cup 301 can be made of plastic, such as injection molded acrylonitrile butadiene styrene (ABS), and fits into a cup opening 145 of a lid 109 to suspend a plant over an underlying tray. The net cup 301 is sized to fit the cup opening 145 and can vary depending on the embodiment, but can be 1-3 inches (2.5-7.5 cm) across, for example, to hold a typical plant. The net cup 301 can include a lip 303 to lap over the edge of cup opening 145 and have a set of tabs 305 to allow the net cup 301 to snap in place and be held securely, where the tabs 305 can be pinched in to remove the net cup 301. As shown in the detail of FIG. 8B or 8C, some embodiments of the net cup 301 can also include a side slot or groove 325 or 325′ around the edge that can be used to hold a support for plants, as discussed in more detail below. In the embodiment of FIG. 8B, the circular arc of groove 325 is configured to hold a support between the groove and a lid 109 into which it is place. For the embodiment of FIG. 8C, the groove is a side slot 325′ is a semi-circular recess to hold the support

The net cup 301 is configured to hold soilless growth medium, such as perlite, gravel, peat, coir (coconut fiber) or other inert medium, into which seeds or young plants can be placed. The embodiment of FIG. 8 holds a peat plug 309 extending down into the net cup 301 and having a top that is more or less flush with the top of the cup. The net cup 301 extends downward, so that when placed into a lid 109 over a tray 101 the bottom of the net cup 301 will be above the bottom of the tray 101 but extend into the water (e.g., aqueous hydroponic nutrient) enough so that the peat plug 309 can wick up the water and plant nutrients. The cup 301 has a net section in that it has openings 307 around its sides, bottom, or both to allow the water in and, as the plant grows, the roots out. Variations on the cup's structure for different crops are discussed in more detail below.

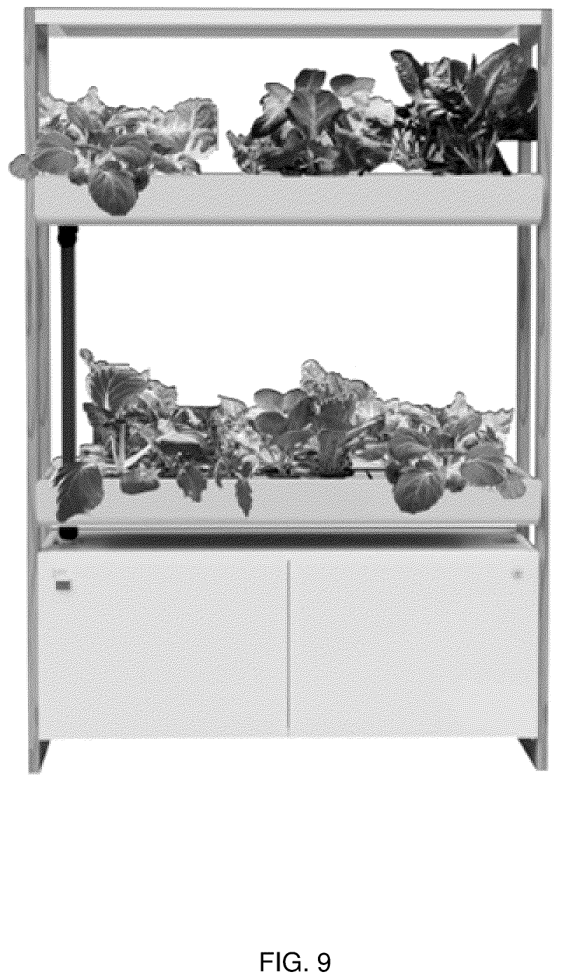

FIG. 9 illustrates an embodiment of the hydroponic system 100 with plants in place. FIG. 9 shows the same view as FIG. 2A, but with net cups installed and plants growing in the cups. As illustrated, a number of different crops can be grown concurrently, where, as described in more detail below, the water profile of the system can be based on the composition and state of development of the plants. The embodiment of FIG. 9 has a taller lower shelf, that can hold taller plants and an upper shorter shelf. For example, the lower shelf could be used for vining crops, such as tomato plants. For vining plants or other plants that can benefit from support, a trellis or other supports can be introduced to the hydroponic growing system. Depending on the embodiment, a plant can be provided with an individual support, a lattice or other support can be common to several plants, or a combination of these.

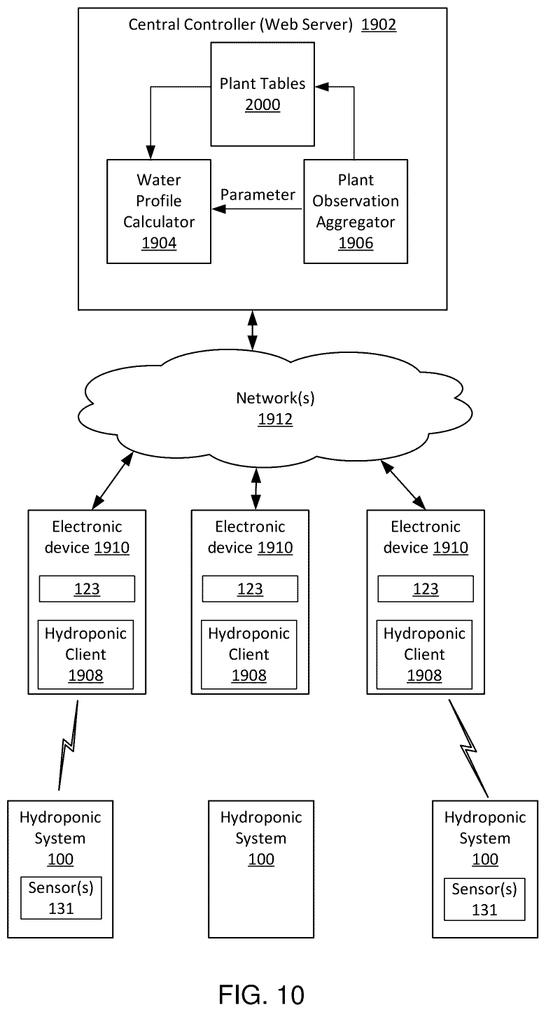

FIG. 10 is a diagram of an environment in which embodiments may be practiced. FIG. 10 depicts several hydroponic systems 100, several electronic devices 1910, and a central controller 1902. The central controller 1902 may also be referred to herein as a “backend.” The hydroponic systems 100 may be implemented by any of the hydroponic systems 100 disclosed herein, but are not limited thereto. In some embodiments, a hydroponic system 100 contains one or more sensors 131 to collect information about the water in the hydroponic system 100. Examples of the one or more sensors 131 include a pH sensor, a water level sensor, and an EC sensor. The hydroponic systems 100 may be configured to report the information collected by the sensors to an electronic device 1910. In one embodiment, wireless communication is used. For example, a hydroponic system 100 and an electronic device 1910 may each have Bluetooth capability. The one or more sensors 131 are not required, as a user could make measurements manually.

The electronic devices 1910 comprise a hydroponic client 1908, which may be software that is executed on the electronic device 1910. The electronic devices 1910 have a display/interface 123 that may be used to display information to a user, as well as allow the user to input information. The electronic devices 1910 could be a device such as, but not limited to, a smart phone, a laptop computer, a tablet computer, desktop computer, or a personal digital assistant. In one embodiment, the hydroponic clients 1908 are configured to collect information about the plants in the hydroponic systems 100 and report that information to the central controller 1902. In one embodiment, the hydroponic client 1908 receives information such as what types of plants are being grown in a hydroponic system 100, as well as the stages of plant growth. Examples of stages of plant growth include, but are not limited to, germination, mid growth, flower, fruit, and harvest. A user may provide this information by way of an interface provided in a display screen 123 of the electronic device 1910. In one embodiment, the hydroponic client 1908 receives plant observations by way of the interface. An example of a plant observation is how long it took a plant to reach a certain growth stage. Another example plant observation is leaf condition (e.g., leaf color, leave drop). The hydroponic client 1908 is configured to provide the information it collects to the central controller 1902. For example, each electronic device 1910 and the central controller 1902 may communicate by means of one or more communication networks 1912 such as the Internet. The one or more networks 1912 allow a particular computing device to connect to and communicate with another computing device. The one or more communication networks 1912 may include one or more wireless networks and/or one or more wireline networks. The one or more networks 1912 may include a secure network such as an enterprise private network, an unsecure network such as a wireless open network, a local area network (LAN), a wide area network (WAN), and/or the Internet. Each network of the one or more networks 1912 may include hubs, bridges, routers, switches, and wired transmission media such as a wired network or direct-wired connection.

The central controller 1902 stores plant tables 2000, which contain information such as nutrient needs of plants, target pH, target amount of light, etc. In one embodiment, there is a separate table for each of several plant growth stages. The water profile calculator 1904 is configured to calculate a water profile for a hydroponic system 100 based on the information received from an electronic device 1910, as well as information in the plant tables 2000. The central controller 1902 provides the water profile to the electronic device 1910, such that the hydroponic client 1908 can either control the hydroponic system 100 to achieve the water profile, or provide instructions to a user as to what nutrients and/or pH adjustments to make to achieve the water profile. Note that an electronic device 1910 can also have a water profile calculator 1904, wherein the electronic device 1910 could calculate the water profile without the assistance of the central controller 1902.

The central controller 1902 has a plant observation aggregator 1906 that is configured to aggregate the plant the observations from the electronic devices 1910. The central controller 1902 is configured to modify the information in the plant tables 2000, in an embodiment. For example, the plant observation aggregator 1906 could modify the nutrient needs of a certain type of plant, based on the collected observations. The plant observation aggregator 1906 is further configured to determine a value for a parameter that is used by the water profile calculator 1904. For example, based on the plant observations, the plant observation aggregator 1906 may determine that the time that it takes a certain type of plant to reach a certain growth stage should be adjusted from 60 days to 58 days. This may cause the water profile calculator 1904 to access a different plant table 2000, in some cases.

A net impact is that this change in parameter value may result in a different water profile from the water profile calculator 1904 for a given set of data. For example, the data may include the amount of time that has passed since a given type of plant (e.g., tomato plant) was started in a hydroponic system 100. The plant may have different nutrient requirements after it reaches this growth stage. Thus, the change from 60 days 58 days to reach the growth stage means that the water profile will change at 58 days instead of at 60 days. Therefore, by aggregating plant observations from many users the accuracy of the water profile can be improved.

The central controller 1902 may be implemented with a computer system having a processor and non-transitory memory. The water profile calculator 1904 and plant observation aggregator 1906 may be implemented by software that is stored in the non-transitory memory and executed on the processor. In one embodiment, the central controller 1902 is referred to as a web server.

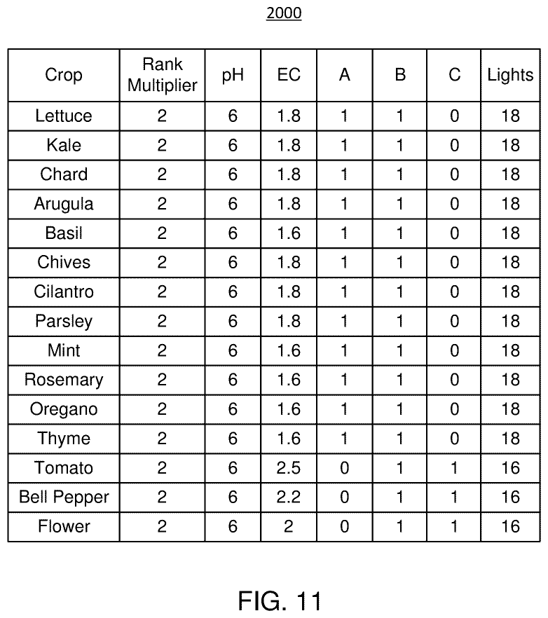

FIG. 11 is table 2000 that defines example conditions and nutrient needs of various types of plants that might be grown in a hydroponic system 100. The table 2000 is for one particular growth stage. There may be a similar table for other growth stages. For example, table 2000 could be for the harvest stage. There may be similar tables for germination, mid-growth, flower, and fruit stages. The table 2000 has a row for each of numerous types of plants (which may also be referred to as “crops”). The rank multiplier is a factor that indicates how much weight is given to the plant in that row during a calculation of a water profile for a hydroponic system 100 that contains multiple types of crops, and will be discussed in more detail below. The pH is a target water pH for the plant in that row, for this stage of plant growth. This example is simplified in that different plants may have a different target pH. The EC (electrical conductivity) is a maximum water EC for the plant in that row, for this stage of plant growth. This example is simplified in that different plants may have a different target EC. Note that the pH and the EC refer to the water that recirculates in the hydroponic system 100.

The columns labeled “A”, “B”, and “C” are for different plant nutrient mixtures. Each nutrient mixture provides a different mix of plant nutrients. In one embodiment, one of the plant nutrient mixtures contains at least one plant nutrient not found in the other two plant nutrient mixtures. For example, one of the plant nutrient mixtures may contain magnesium, whereas the other two do not. In one embodiment, two of the plant nutrient mixtures contain the same plant nutrients, but the concentrations of at least some of the plant nutrients are different. For example, one of the mixtures may provide a much larger amount of potassium than the other. In one embodiment, the plant nutrient mixtures are hydroponic nutrient solutions. A hydroponic nutrient solution is a concentrated aqueous solution that contains plant nutrients.

In one embodiment, two of the plant nutrient mixtures provide Fe, N, Ca, and K. However, the concentration (in ppm) of at least some of these plant nutrients is different. For example, the concentration of N and Ca might be higher in nutrient mixture A than in nutrient mixture C; however, the concentration of K might be higher in nutrient mixture C. It is not required for all of the plant nutrients to have different concentrations. For example, the concentration of Fe might be the same in nutrient mixture A and nutrient mixture C.

In one embodiment, one the plant nutrient mixtures provides Mg, S, B, Cu, Zn, Mn, Mo, Na, K, and P. For example, nutrient mixture B might contain these plant nutrients, whereas plant nutrient mixture A and plant nutrient mixture C might not contain any of these. However, plant nutrient mixture A and/or plant nutrient mixture C could contain one or more of Mg, S, B, Cu, Zn, Mn, Mo, Na, K, and P.

There could be more than three different plant nutrient mixtures. In one embodiment, only two different plant nutrient mixtures are used. There are a multitude of ways that plant nutrient mixtures may be formulated such that each plant nutrient mixture provides a different mix of plant nutrients.

The values in the rows in the plant nutrient mixture columns may be referred to herein as “Nutrient Ratios.” The Nutrient Ratio is expressed as A/B/C, in one embodiment. For example, the nutrient ratio in table 2000 for lettuce is 1/1/0. In this example, the nomenclature “Nutrient Ratio A” will be used to refer to the value of “A”, “Nutrient Ratio B” will be used to refer to the value of “B”, and “Nutrient Ratio C” will be used to refer to the value of “C.” For example, for lettuce, Nutrient Ratio A has a value of 1, Nutrient Ratio B has a value of 1, and Nutrient Ratio C has a value of 0. As noted above, the plant nutrient mixtures in table 2000 are hydroponic nutrient solutions, in one embodiment. When the plant nutrient mixtures are hydroponic nutrient solutions, these nutrient ratios may be referred to as “ratios of hydroponic nutrient solutions.”

The pH, EC, and “Nutrient Ratios” in table 2000 are one way to specify a water profile. The values in each row of table 2000 are one example of a water profile for each crop. In some embodiments, a single water profile is determined for all of the crops in a hydroponic system 100.

The column labeled “lights” indicates a target amount of light for the plant in that row. The value is a number of hours of light per day, in one embodiment. The nature of the light (e.g., intensity, color) may also be specified.

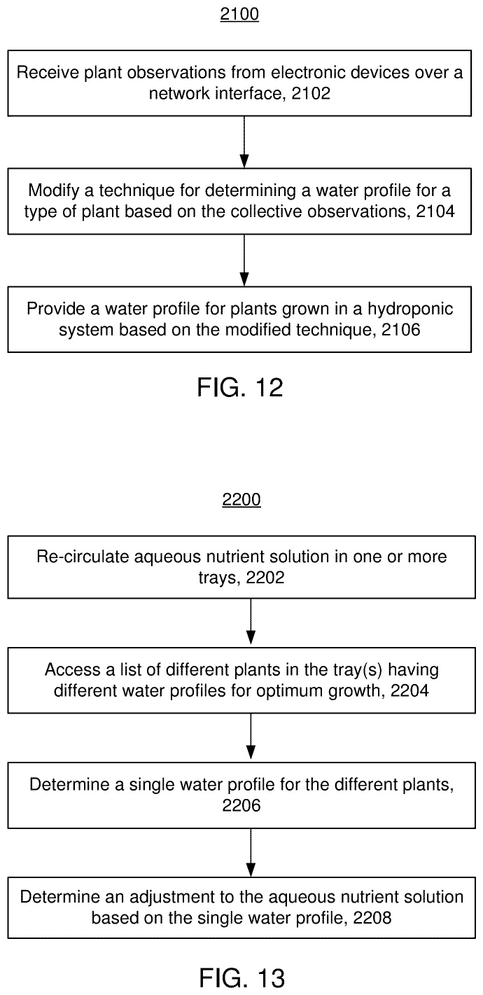

FIG. 12 is a flowchart of one embodiment of a process 2100 of providing a water profile for plants in a hydroponic system 100. The process 2100 is implemented by the central controller 1902, in one embodiment. Step 2102 includes the central controller 1902 receiving plant observations from electronic devices 1910. The plant observations are provided by a user of a hydroponic system 100, in an embodiment. In one embodiment, the plant observations include data on how long it took a type plant to reach a certain growth stage. For example, the plant observations from one user may include data of how many days it took a tomato plant to reach the fruit stage. If the user has multiple tomato plants, the user might provide data for each plant. Another example observation is leaf conditions. For example, if a user notices that a plant has leaves that brown, this may be an indication of a problem with the water profile (e.g., the plant nutrients or pH). If many user's report such problems, this may be an indication that the central controller 1902 should change the water profile it provides, at least for hydroponic systems 100 that might be impacted by the foregoing problem with leaves turning brown.

Step 2104 includes the central controller 1902 modifying a technique for determining a water profile of one of more types of plants are determined based on the collective observations. One way in which the water profile may be specified is by table 2000 (or a similar table for other plant stages). With respect to table 2000, the water profile may include some or all of pH, EC, Nutrient Ratio A, Nutrient Ratio B, Nutrient Ratio C. The water profile could be specified in another manner, such as ppm of various plant nutrients. One way to modify the technique for determining the water profile is to change one or more values in table 2000 (or a similar table for other plant stages). Another way to modify the technique for determining the water profile is to change what table 2000 is selected. For example, the central controller may determine that, based on the collective observations, tomato plants are reaching the fruit stage sooner than expected. Thus, the central controller 1902 may access a different plant table 2000 to determine the nutrient needs of tomatoes. As another example, the collective observations may be that a certain type of plant being grown in hydroponic systems 100 are exhibiting brown leaves, which may be an indication that the nutrition for that plant is not correct. Thus, the central controller 1902 may modify the nutrient needs (e.g., the values in columns labeled “A”, “B” and/or “C”) in table 2000 to correct the nutrient problem.

Step 2106 includes providing a water profile for plants grown in a hydroponic system 100 to at least one of the electronic devices 1910 based on the modified technique for determining the water profile for the specified type of plant. The water profile may be specified in a number of ways. In one embodiment, the water profile is specified as a first amount of Nutrient mixture A, a second amount of Nutrient mixture B, and third amount of Nutrient mixture C. In this example, the amount of one or two of the nutrient mixtures may be zero. The water profile could be specified in terms of ppm of various plant nutrients. The water profile could be specified in terms of amounts of various salts that provide the plant nutrients.

FIG. 13 is a flowchart of one embodiment of a process 2200 of providing a water profile for plants grown in a hydroponic system 100. Process 2200 is implemented by a control circuit, in one embodiment. Any combination of control circuitry 121, electronic device 1910 and/or central controller 1902 may be considered to be a control circuit for performing functionality described herein. Steps 2204-2208 of process 2200 are implemented by the central controller 1902, in one embodiment. Steps 2204-2208 of process 2200 are implemented by the hydroponic client 1908 that executed on an electronic device 1910, in one embodiment.

Step 2202 includes re-circulating an aqueous nutrient solution in one or more trays 101 in a hydroponic system 100. Step 2202 includes re-circulating the water containing plant nutrients (e.g., an aqueous nutrient solution), using a water re-circulation system, in one embodiment.

Step 2204 includes accessing a list of different plants (or crops) in the tray(s) 101. The plants have different water profiles for optimum health, in one embodiment. For example, tomatoes may have different nutrient needs than lettuce. In one embodiment, the step 2204 also includes accessing a growth stage of at least some of the plants. The nutrient needs of at least some of the plants may depend on the growth stage.

Step 2206 includes determining a single water profile for the different plants in the hydroponic system 100. In some embodiments, step 2206 includes determining a weighted average of the nutrient needs of the various plants in the hydroponic system 100. Further details of embodiments of determining a single water profile are described below.

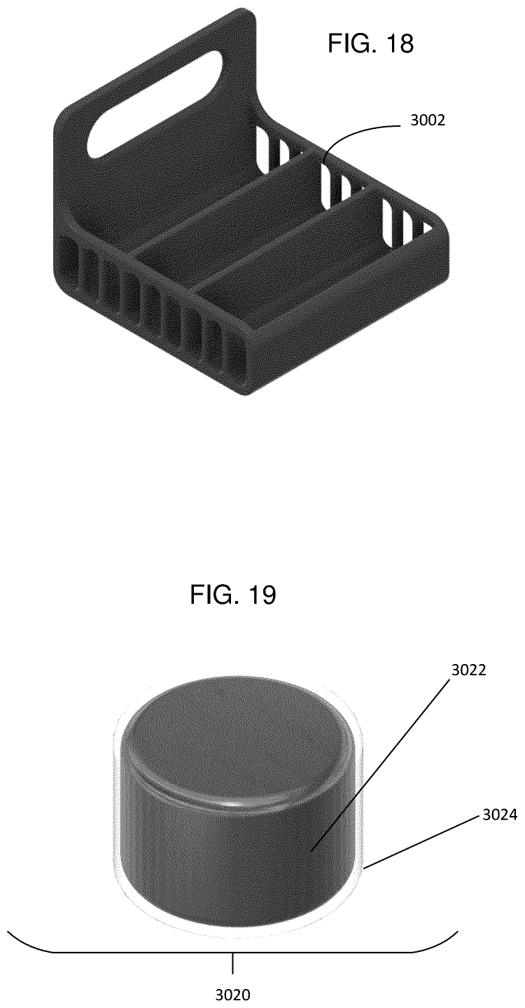

Step 2208 includes determining an adjustment to the aqueous nutrient solution based on the single water profile. In one embodiment, the central controller 1902 provides the water profile to an electronic device 1910 (that executes the hydroponic client 1908). In one embodiment, the hydroponic client 1908 has a user interface 123 that provides instructions for a user to make water adjustments. For example, the instructions tell the user how much of Nutrient A, Nutrient B, and/or Nutrient C to add to the water that is re-circulated in the hydroponic system 100. In one embodiment, the hydroponic client 1908 automatically makes the water adjustments by causing various nutrients to be added to the water that is re-circulated in the hydroponic system 100. In one embodiment, user interface 123 that provides instructions for a user to load nutrient capsules in a capsule holder and instructs the user as to the physical configuration to implement for the capsule holder, as described below with respect to FIGS. 18-30.

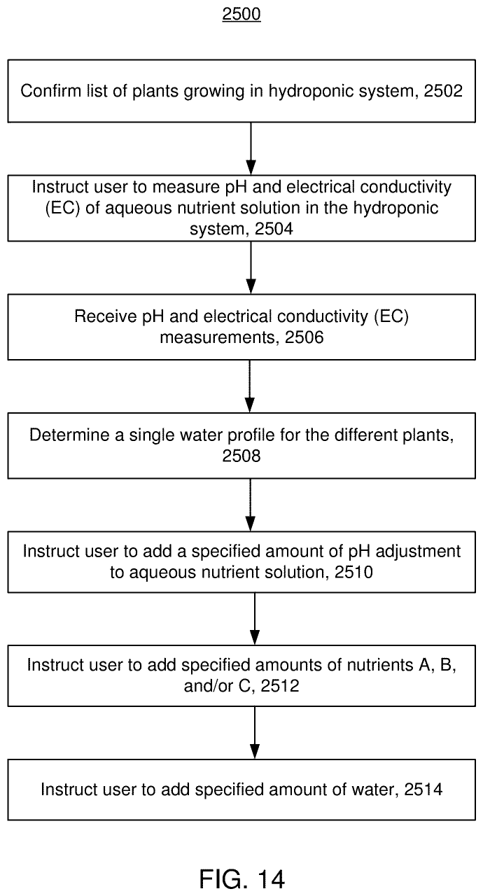

FIG. 14 is a flowchart of one embodiment of a process 2500 of adjusting a water profile for plants grown in a hydroponic system 100. The hydroponic system 100 includes a water re-circulation system that recirculates water that contains plant nutrients (e.g., an aqueous nutrient solution), in one embodiment. Process 2500 is one embodiment of process 2200. Process 2500 is implemented by the control circuit, in one embodiment.

Step 2502 includes confirming a list of different plants in the tray(s) 101. Step 2504 includes instructing the user to measure the pH and the EC of the aqueous nutrient solution that is being re-circulated in the hydroponic system 100. Step 2506 includes receiving the pH and EC measurements. For example, the hydroponic client 1908 accesses the pH measurement from field 2412. The EC measurement may be obtained in a similar manner. Step 2508 includes determining a single water profile for the different plants. Step 2508 is performed by the hydroponic client 1908. In one embodiment, the hydroponic client 1908 sends information to the central controller 1902, which determines the water profile and sends the water profile to the hydroponic client 1908. Step 2510 includes instructing the user to add specific amounts of pH adjustment to the aqueous nutrient solution that is being re-circulated in the hydroponic system 100. Step 2512 includes instructing the user to add specific amounts of Nutrient A, Nutrient B, and/or Nutrient C to the water that is re-circulated in the hydroponic system 100. In one embodiment of step 2512, user interface 123 provides instructions for a user to load nutrient capsules in a capsule holder and instructs the user as to the physical configuration to implement for the capsule holder, as described below with respect to FIGS. 18-30. Step 2514 includes instructing the user to add a specific amount of water to the water that is re-circulated in the hydroponic system 100. This water could be tap water, bottled water, reverse osmosis (RO) water, etc.

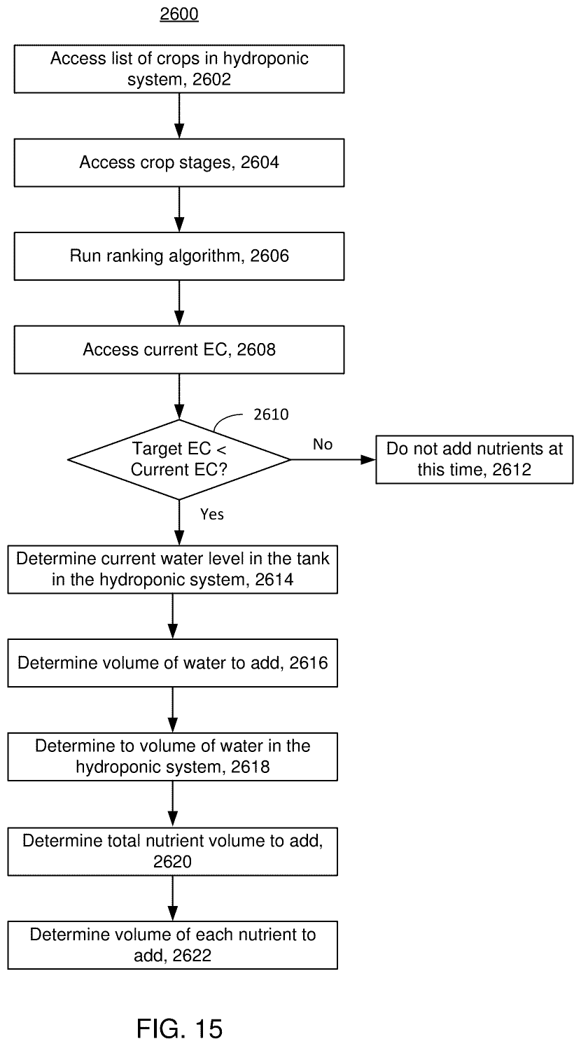

FIG. 15 is a flowchart of one embodiment of a process 2600 of determining an amount of nutrients to add to the hydroponic system 100. The process 2600 may be used in one embodiment of any of steps 2206, 2306, and/or 2508. Process 2500 is implemented by the control circuit, in one embodiment.

Step 2602 includes a list of crops (or plants) in the hydroponic system 100. The user may enter/modify a list of crops at any time. The list of crops may be stored for future reference. In one embodiment, list is stored on the electronic device 1910. In one embodiment, the list is stored on the central controller 1902.

Step 2604 includes accessing crop stages. The crop stages are determined based on days from germination or planting, in one embodiment. For example, the user may provide the date that a specific crop was planted in the hydroponic system 100. This information can be provided at any time. In one embodiment, this date is stored with the list of crops.

Step 2606 includes running a ranking algorithm. The ranking algorithm is used to determine what nutrients to add based on assigning different weights to different plants. The ranking algorithm determines a relative amount of each of Nutrient A, Nutrient B, and Nutrient C, in one embodiment. For example, the ranking algorithm may determine that the relative amounts of the three nutrients respectively should be: 0.5/1/0.25. Herein the value in this relationship is referred to as its “Nutrient Ratio.” For example, Nutrient A may be assigned a Nutrient Ratio of 0.5, Nutrient B may be assigned a Nutrient Ratio of 1.0, and Nutrient C may be assigned a Nutrient Ratio of 0.25.

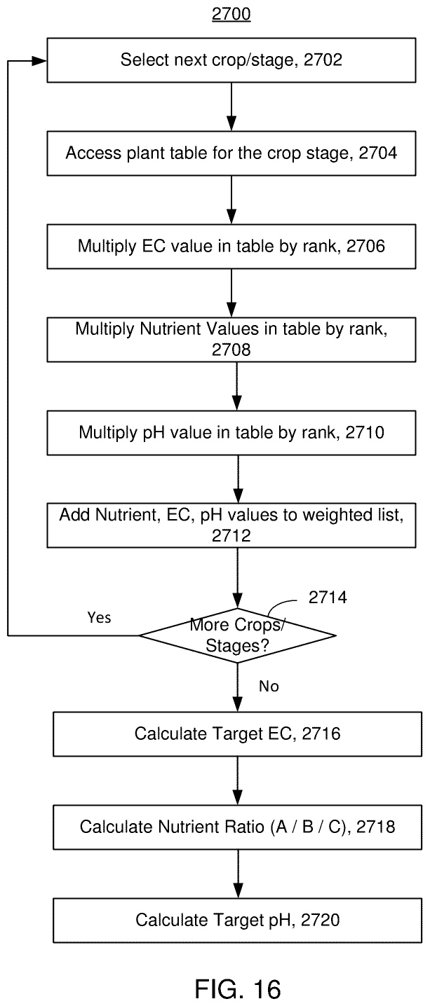

Each crop is assigned a rank multiplier, in one embodiment. With reference to FIG. 11, each crop has a rank multiplier of 2 for the crop stage in that table 2000. However, different crops could have different rank multipliers for the same crop stage. Also, the rank multiplier for a given crop depends on the crop stage, in one embodiment. The ranking algorithm also determines a target EC, in one embodiment. One embodiment of a ranking algorithm is depicted in FIG. 16.

Step 2608 includes access the current EC of the water in the hydroponic system 100. This may be accessed automatically by the hydroponic client 1908. This may be accessed based on user input, as in step 2504 of FIG. 14.

Step 2610 includes a determination of whether the target EC is less than the current EC. Note that the target EC is determined by the ranking algorithm, in one embodiment. If the target EC is less than the current EC, then the process continues at step 2614. However, if the target EC is not less than the current EC, then no nutrients are added to the hydroponic system 100 at this time (step 2612).

Step 2614 includes determining the current water level in tank 111 of the hydroponic system 100. Step 2614 may include accessing a measurement of the water level in the tank 111. In one embodiment, water level sensor 125 is used to monitor the current water level in the tank 111. In one embodiment, the user observes the water level in the tank 111 and reports it in an interface.

Step 2616 includes determining a volume of water to add to the hydroponic system 100. In one embodiment, this is based on the level in the tank 111. If the level in the tank 111 is at a sufficient level, then it is not required that any water be added. In one embodiment, a calculation is made of the difference between a “full level” in the tank 111, and the present level. The user is instructed to add enough water to reach the full level, in one embodiment.

Step 2618 includes determining the total water volume in the hydroponic system 100. In one embodiment, the volume of water in each tray 101 is known based on the physical configuration of the tray (e.g., length, width, water level due to dam height). The total water volume in the hydroponic system 100 may be determined by adding the water volume in each tray 101 and the tank 111.

Step 2620 includes determining a total volume of nutrient to add to the hydroponic system 100. In one embodiment, a weighted average equation is used to determine the total volume of nutrient to add. Equation 1 is an example weighted average equation.

$${Vol}_{n} = \frac{\frac{{EC}_{s} * {Vol}_{s} + {EC}_{w} * {Vol}_{W}}{{EC}_{f}} - {Vol}_{s} - {Vol}_{w}}{\sum ratios - \frac{{EC}_{A} + {EC}_{B} + {EC}_{C}}{{EC}_{f}}} \qquad Eq . 1$$

In Equation 1, Volₙ is the total volume of nutrient to add. In Equation 1, ECₛ is the current EC of the water in the system 100 (before adding water or nutrients), Vols is the total water volume in the hydroponic system 100 (before adding water or nutrients), EC, is the EC of the water that is added to the system 100, Vol_{w} is the water volume added to the system 100. In Equation 1, the summation of the ratios refers to the summation of the nutrient ratios that were determined by the ranking algorithm. EC_{A}, EC_{B}, and EC_{C} are EC change constants. These change constants are based on the EC of the Nutrients A, B, and C. In Equation 1, EC_{F} is the target EC, which is provided by the ranking algorithm.

Step 2622 includes determining a volume of each nutrient to add to the hydroponic system 100. In one embodiment, this is determined by multiplying the volume of nutrient to add (Volₙ) by the respective nutrient ratios, as indicated by Equations 2-4. The nutrient ratios are provided by the ranking algorithm of FIG. 16, in one embodiment.

Nutrient Volume A=Volₙ*Nutrient Ratio A Eq. 2

Nutrient Volume B=Volₙ*Nutrient Ratio B Eq. 3

Nutrient Volume C=Volₙ*Nutrient Ratio C Eq. 4

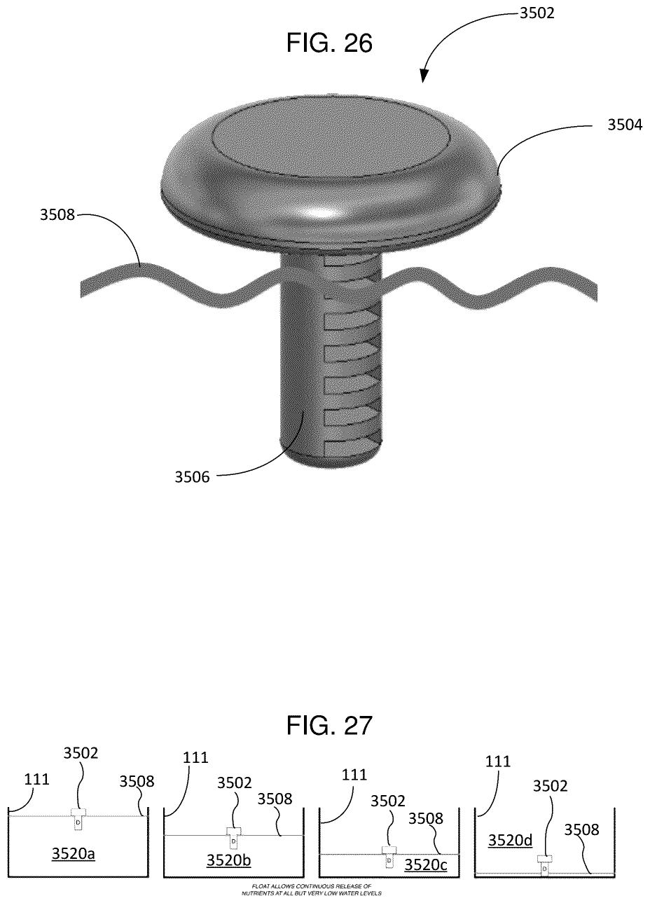

FIG. 16 is a flowchart of one embodiment of a process 2700 of a ranking algorithm. The process 2700 may be used in one embodiment of step 2606 in FIG. 26. Process 2700 is implemented by the control circuit, in one embodiment. Process 2700 in general loops through a calculation in which one crop/stage is processed at a time. A crop/stage refers to a crop in the hydroponic system 100 at a specific stage of development. If a type if crop (e.g., tomatoes) have plants at two or more stages of development in the hydroponic system 100, each stage can be processed in a separate loop. The crops and their stages may be learned in steps 2602 and 2604 of process 2600.

Step 2702 includes selecting first crop/stage in the hydroponic system 100. Based on the stage, an appropriate plant table 2000 is selected, in step 2704. For example, a fruit stage table 2000 is selected if the plant is at a fruit stage.

Step 2706 includes multiplying the EC value in the plant table 2000 by the rank multiplier for this crop. Table 2000 shows an example in which each crop has a rank multiplier. Step 2708 includes multiplying nutrient values in the plant table 2000 by the rank multiplier for this crop. The nutrient values are listed in the columns labeled “A”, “B”, and “C.” Thus, this produces a value for each Nutrient. Step 2710 includes multiplying the pH value in the plant table 2000 by the rank multiplier for this crop. The amount of the crop in the hydroponic system 100 may also be factored into the calculations in steps 2706-2710. For example, the number of tomato plants, the number of net cups containing tomato plants, the number of lids containing tomato plants, or some other measure may be factored in as another multiplier in steps 2706-2710.

Step 2712 includes adding the nutrient, EC, and pH values from steps 2706-2710 to a weighted list. Step 2714 is a determination of whether there are more crop/stages to process. The process then returns to step 2702 to process the next crop/stage. Each time through the values for the nutrient, EC, and pH values from steps 2706-2710 are summed with the existing values. Thus, the weighted list produces a sum of the values for each crop/stage.

After all crop/stages have been processed, step 2716 is performed. Step 2716 includes calculating a target EC. In one embodiment, the target EC is the arithmetic mean of the values from step 2706. The mean may be determined from the weighted list of step 2712. The target EC may be used in step 2610 of process 2600. The target EC may also be used in step 2620 of process 2600.

Step 2718 includes calculating Nutrient Ratios (e.g., Nutrient Ratio A, Nutrient Ratio B, Nutrient Ratio C). In one embodiment, the Nutrient Ratios are the arithmetic means of the values from step 2708. The mean may be determined from the weighted list of step 2712. The Nutrient Ratios may be used in steps 2620 and 2622 of process 2600.

Step 2718 includes calculating a target pH. In one embodiment, the target pH is the arithmetic mean of the values from step 2710. The mean may be determined from the weighted list of step 2712.

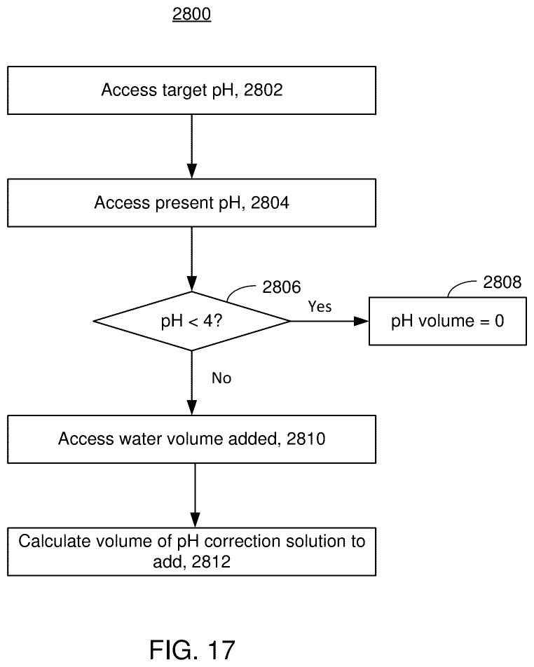

FIG. 17 is a flowchart of one embodiment of a process 2800 of pH correction. For example, the process determines an amount of pH correction solution to add to the hydroponic system 100. Process 2800 is implemented by the control circuit, in one embodiment. Step 2802 includes accessing a target pH. In one embodiment, the target pH is taken from step 2720 of process 2700. Step 2804 includes accessing the present pH of the water in the hydroponic system 100. The present pH could have been determined in step 2304 of process 2300, or 2504 of process 2500. If the present pH is less than 4 (step 2806=yes), then no pH correction is performed. Thus, the volume of pH correction solution is set to zero, in step 2808. If the pH is not less than 4, then the process goes on to step 2810. In step 2810, the water volume added (or to be added) to the hydroponic system 100 is accessed. The water value to add may be determined in step 2616 of process 2600.

Step 2812 is a determination of the pH correction solution to add to the water in the hydroponic system 100. In one embodiment, the volume of water that is added is divided by a factor to determine the volume of pH correction solution to add. The factor will depend on the impact of the pH correction solution.

To provide nutrients to plants in the hydroponic plant growing system, a nutrient release capsule and a capsule holder are used. FIG. 18 depicts one example of a capsule holder 3002, which is a physical structure that holds one or more capsules in the correct position to be dissolved into the water (or other liquid) of a hydroponic plant growing system. The user will be able to remove and clean all components of the capsule holder 3002 with ease. In one embodiment, capsule holder 3002 contains several chambers to allow for the combination of capsules where the chemical composition may impact how many capsules a user adds to their system.

FIG. 19 depicts one embodiment of a capsule 3020, which (in one embodiment) includes a powdered hydroponic fertilizer center (or content) 3022 with a biopolymer outer coating (or enclosure) 3024 to slow release of the hydroponic plant fertilizer when the capsule is in contact with water (or other liquid). In one embodiment, the capsule content 3022 is a mixture of nutrients salts that is specifically designed to grow hydroponic plants. In one embodiment, this is a single part nutrient formula that will grow plants at any stage and of any variety. In one example, there are three unique core formulas, one for sprouting plants, one for flowering and one for fruiting. In one embodiment, this capsule center is completely water soluble and dissolves without residue.

In one embodiment, the capsule content 3022 includes an array of pre-mixed and fully homogenized fertilizer salts that contain macro and micro nutrients with the following contents: Iron, Zinc, Sulfur, Boron, Molybdate, Copper, Calcium, Phosphorus, Potassium, Manganese, and Magnesium. This also may include but is not limited to: bulking powder to increase the volume of the product, binding agents to hold them together, flowing agents for passing through machinery, and thickening agents to keep chemicals together.

In one embodiment, the enclosure 3024 is a physical or chemical outer enclosure that holds onto the capsule center and is entirely water soluble. This structure may contain elements of time staggered solubility to aid in mixing and reducing precipitates, or aid in user handling of the capsule.

In one embodiment, the capsule enclosure 3024 is made up of a starch-based biopolymer that can be derived from several different products, including food-grade tapioca (or other starch-based product). The biopolymer is treated with Polyvinyl Alcohol (PVOH) in order to produce a gelatin material that will act as a hydrophobic matrix, decreasing the rate of dissolution into the water reservoir of the indoor hydroponic garden. Citric acid is used as a crosslinker in order to change the pH of the material for better bonding between the starch and the PVOH. This is adhered to the capsule content 3022 to create a coating.

The methods in which the capsule enclosure 3024 is bonded to the capsule content 3022 may include, but are not limited to: rotary drum method, immersion method, or a fluidized bed method.

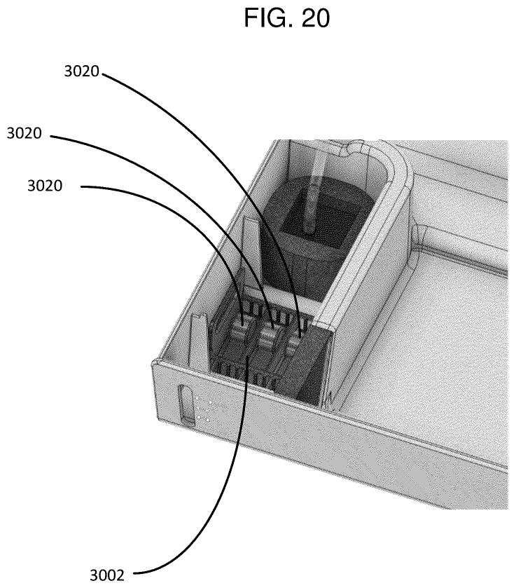

FIG. 20 depicts capsule holder 3002 positioned in the hydroponic plant growing system, and housing multiple capsules 3020. Capsule holder 3002 interfaces directly with the plumbing system of the hydroponic plant growing system such that system's water (or other liquid) dissolves and dissipates the capsule center evenly throughout the entire hydroponic plant growing system.

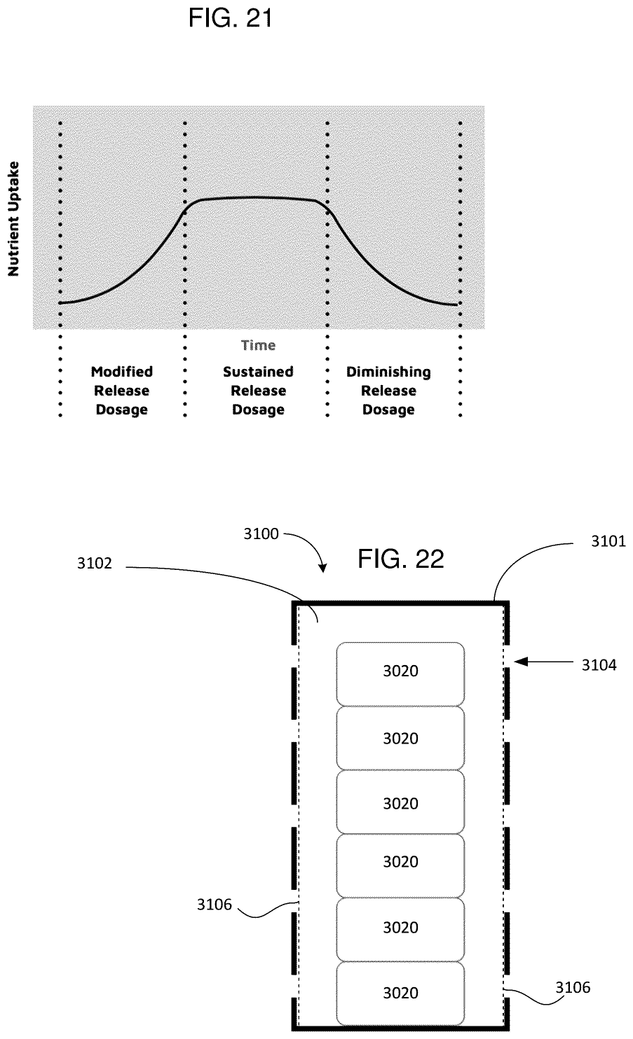

FIG. 21 is a graph of nutrient uptake (from one or more capsules) by the plants of the hydroponic plant growing system versus time, and can be a nutrient uptake map as a function of how the garden's nutrient levels should be managed given a set time. The nutrient uptake map of FIG. 21 shows three different release dosage behaviors: modified release, sustained release, and diminishing release. During the period of modified release, the plants experience an increasing rate of release of the hydroponic plant fertilizer from the capsule. During the period of sustained release, the plants experience a constant rate of release of the hydroponic plant fertilizer from the capsule. During the period of diminishing release, the plants experience a decreasing rate of release of the hydroponic plant fertilizer from the capsule.

The nutrient uptake map of FIG. 21 is a theoretical model that is fed into a software based algorithm (running on Central Controller 1902 or Electronic Device 1910) in order to predict the behavior of a hydroponic plant growing system's plants in terms of how much nutrients they will need over x amount of time. The algorithm outputs a nutrient profile based on the number of plants in a hydroponic plant growing system, the variety of those plants, and the ages of those plants. When a nutrient profile is generated, calculating the rate of change over time x provides the nutrient uptake rate for that hydroponic plant growing system for that period of time. This is possible because the system knows from user input exactly what each plant is and at which stage of growth it is in. Additionally, the system knows which plants will enter the system in the future because the user has started them in their Nursery (prior to inserting into the hydroponic plant growing system), which means they are planning to put them into the hydroponic plant growing system (garden). All of these factors contribute to the volume of nutrients needed to grow that specific arrangement of plants which is the output of the algorithm. Collecting that value over x time provides the rate. This rate is then matched with the nutrient uptake map, to see which release dosage behavior is desired to obtain: modified release, sustained release, or diminishing release dosage. This information is compiled and communicated to the user (e.g., via a user interface on the software application) as a setting for the capsule holder.

FIG. 22 depicts one embodiment of a capsule holder 3100 configured to hold multiple capsules 3020. Capsule holder 3100 comprises an enclosure 3101. Inside enclosure 3101 is an interior space 3102 for housing the capsules 3020. Enclosure 3101 includes apertures in the enclosure to allow for transmission of a liquid (e.g., water) between outside of enclosure 3101 and interior space 3102. FIG. 22 only labels one of the apertures 3104 to keep the drawing easy to read, but it is contemplated that enclosure 3101 includes many apertures. Lining the inner wall of enclosure 3101 is a filter 3106 that is configured to filter the liquid flowing through the apertures. Filter 3106 also allows for filtering of any and all of the fillers, binders, coatings, and other undissolved material that is left behind after the capsules 3020 have completed their cycles. One drawback of some powdered, tablet, or coated plant fertilizer products, and even biopolymers is that they will not always dissolve 100% over the course of their cycle. With the continued usage of this product, filtering ensures that physical buildup does not occur within the reservoir or the plumbing of the hydroponic plant growing system. In one embodiment, filter 3106 is made of metal or mesh.

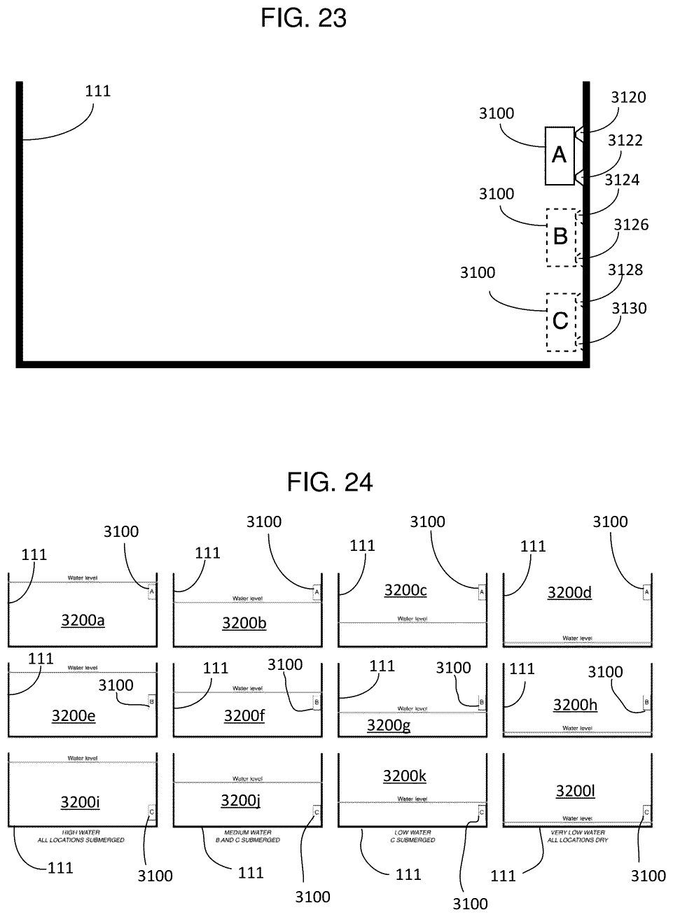

In one embodiment, enclosure 3101 includes one or more connectors that connect to any one or more of a set of connectors mounted at different vertical positions of tank 111 such that the capsule holder (including enclosures 3101) can be positioned at three different vertical positions of tank 111 (i.e., three different configurations). The connectors can be any suitable type of connector known in the art. No specific connector structure is required. In one embodiment the connectors includes male/female connectors that snap together. In this manner, the capsule holder is configured to have multiple physical configurations corresponding to the vertical position of enclosure 3101. This embodiment is depicted in FIG. 23, which shows tank 111 having three sets of connectors, including connectors 3120 and 3122 that connect to connectors (not depicted) on enclosure 3101 to hold enclosure 3101 at position A on tank 111, connectors 3124 and 3126 that connect to connectors (not depicted) on enclosure 3101 to hold enclosure 3101 at position B on tank 111, and connectors 3128 and 3130 that connect to connectors (not depicted) on enclosure 3101 to hold enclosure 3101 at position C of tank 111. Positions A, B and C are at different vertical positions on tank 111.

When operating the hydroponic plant growing system discussed above, a user will be periodically instructed (e.g., every two weeks, every month, etc.) by the software on electronic device 1910 to fill tank 111 with water. Between fillings, the water level will slowly dissipate. By connecting enclosure 3101 to positions A, B or C, the appropriate release dosage behavior is obtained (e.g., modified release, sustained release, or diminishing release—see FIG. 21). In other embodiments, more or less than three positions can be used.

In the embodiment of FIG. 23, the capsule holder 3100 is placed into the water reservoir of the hydroponic plant growing system discussed above where it can interact with the changes to the water level. The specific and calculable changes in the water level allow for the mapping of the three nutrient uptakes (e.g., modified release, sustained release, or diminishing release—see FIG. 21) to the physical system. The three physical configurations of the capsule holder comprise the mounting at the pre-determined heights inside the water reservoir: A, B, and C. Note that in one embodiment, capsule holder 3002 of FIG. 18 can include connectors to connect to any of connectors 3210-3130.

FIG. 24 depicts tank 111 with capsule holder 3100 mounted at the three above-described three positions (A, B and C) at different water levels. Examples 3200a, 3200b, 3200c and 3200d show capsule holder 3100 mounted to tank 111 at position A, with the water level becoming lower from 3200a to 3200d. Examples 3200e, 3200f, 3200g and 3200h show capsule holder 3100 mounted to tank 111 at position B, with the water level becoming lower from 3200e to 3200h. Examples 3200i, 3200j, 3200k and 3200l show capsule holder 3100 mounted to tank 111 at position C, with the water level becoming lower from 3200i to 3200l.

Position A maps to the Diminishing Release Dosage (see FIG. 21) where the capsule holder is fully submerged and allowed to dissolve its nutrients into the water. Then as the plants drink up the water, the capsule holder 3100 loses contact with the water, resulting in a decrease in the nutrient concentration.

Position B maps to the Sustained Release Dosage of nutrients where the balance between the initial dissolution and the rate of that dissolution (controlled by the layer thickness of the starch biopolymer) matches the water uptake rate, without allowing for buildup of nutrient concentration with the last two stages of time being out of the water this leads to a continual level of nutrients that does not go up or down with time.

Position C maps to the Modified Release Dosage where the combination of continual contact with capsule holder 3100 releases nutrients at a faster rate than the plants are initially taking up, resulting in an amplification of the nutrient concentration.

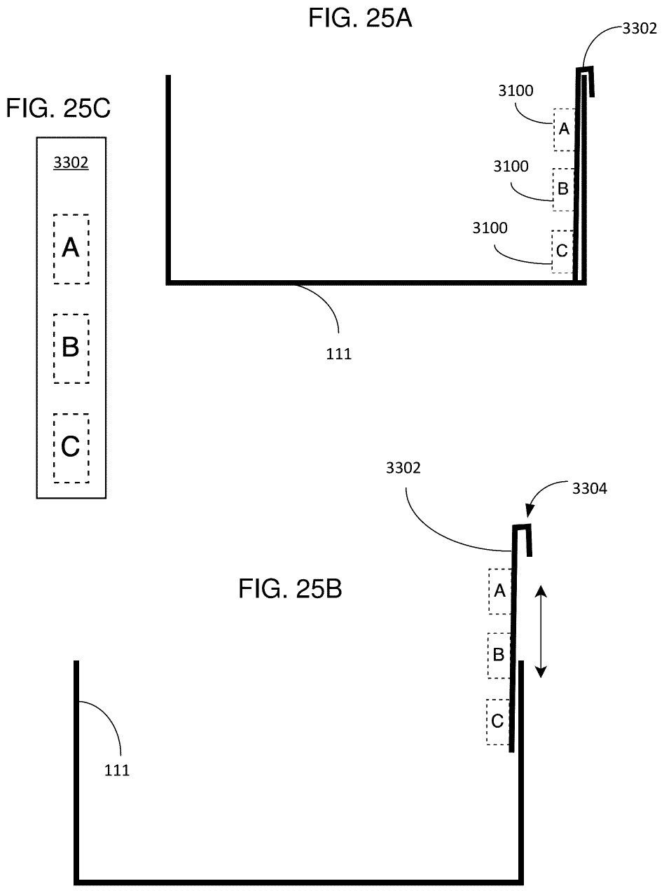

In one embodiment, the connectors 3120-3130 are directly mounted on the tank. In another embodiment, the connectors 3120-3130 are mounted at different vertical positions on a vertically elongated post 3302 having a flange 3304 at a top end such that the flange 3304 is configured to wrap around the top of tank 111 and removably support the post 3302 inside tank 111, as depicted in FIGS. 25A and 25B. FIG. 25C shows the front face of post 3302, indicating positions A, B and C. The connectors on capsule holder 3100 (e.g., the connectors on the outside surface of housing 3101) are configured to be coupled to the any of the multiple connectors mounted at different vertical positions on the vertically elongated post. FIG. 25A shows post 3302 fully inserted into tank 111. FIG. 25B shows post 3302 pulled up out of tank 111 so that the user can easily retrieve capsule holder 3100 without contacting the nutrient dense water (causing contamination of the water from contaminants on the user's hand and/or getting the user dirty). The user can rinse out the filter, and refill capsule holder 3100 before setting to the capsule holder 3100 to the correct height (e.g., positions A, B or C) and adding it back to their hydroponic plant growing system.

FIGS. 26-29C describe another embodiment of a capsule holder in the form of a floating vessel that, instead of engaging with three different heights of the water, stays in constant contact with the water but allows the mapping of the three nutrient uptakes to happen through rotating a gate that opens and closes apertures on the sides of the capsule holder. The floating mechanism allows for easy retrieval of the capsule holder, minimizing the interaction between the user's hands and the nutrient dense water

FIG. 26 shows capsule holder 3502, which includes a buoyant head 3504 attached to the top of the body 3506, where the body 3506 includes a cavity for housing one or more capsules 3020. In one embodiment, body 3506 is the same (or similar) structure as enclosure 3101 (including apertures 3104 and filter 3106). FIG. 26 shows capsule holder 3502 floating at water level 3508 such that buoyant head 3504 is above water level 3508 and all or most of body 3506 is below water level 3508.

The user will fill the inner chamber of the enclosure with capsules, place it into the water. When nutrient is complete, capsule holder 3502 will be removed so the filter can be cleaned, stopping any undissolved material from entering the reservoir. The capsule holder 3502 floats on the surface of the water so that the user can easily extract, clean and refill the device.

FIG. 27 depicts tank 111 with capsule holder 3502 floating at different water levels. Examples 3520a, 3520b, 3520c and 3520d show the water level progressively becoming lower, thereby lowering capsule holder 3052. In example 3520d, the water level is so low that a portion of body 3506 is above water level 3508. Thus, the floating capsule holder allows for continuous release of nutrients at all but very low water levels.

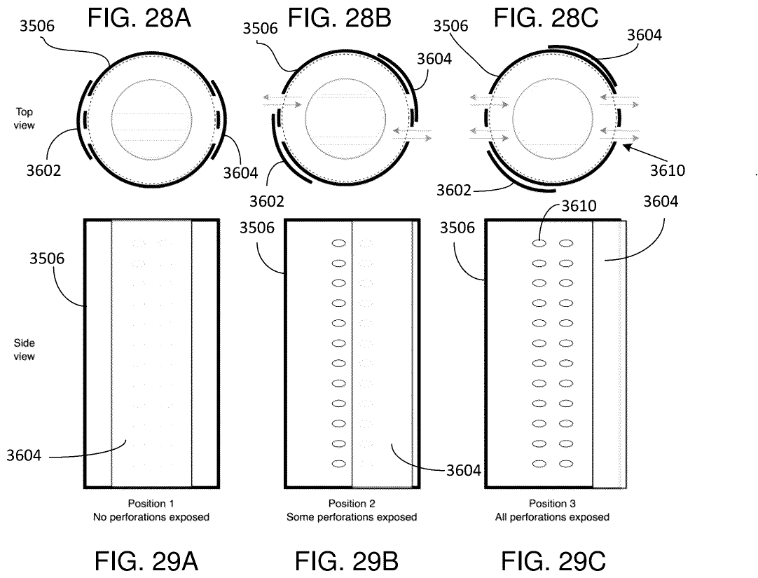

FIGS. 28A-C show a top cross sectional view of body 3506 at three different physical configurations. FIGS. 29A-C show a side view of body 3506 at the same three physical configurations. Mounted underneath buoyant head 3504 is a rotating gate 3602 and rotating gate 3604. In one embodiment rotating gate 3602 and rotating gate 3604 are separate structures. In one embodiment rotating gate 3602 and rotating gate 3604 are connected to form one structure. In one embodiment, rotating gates 3602/3604 have three positions (corresponding to the three different physical configurations of the capsule holder). In a first position (first physical configuration), corresponding to FIG. 28A and FIG. 29A, gates 3602 and 3604 cover all of the apertures. However, the seal between the gates 3602/3604 and the enclosure is not water tight so that some small amount of liquid will leak in or out. This position allows for only the slightest amount of water to pass through the gates which leads to less nutrients being released into the water than the plants can take up over time x. This maps to the Diminishing Release Dosage.

In a second position (second physical configuration), corresponding to FIG. 28B and FIG. 29B, gates 3602 and 3604 cover some (e.g., half) of the apertures. This position maps to the Sustained Release Dosage where the volume of water let into the chamber, in combination with the release rate of the Nutrient Release Capsule, provides the same concentration of nutrients to the system over time x. This means it is dispensing nutrients at the same rate as the plants are taking them up.

In a third position (third physical configuration), corresponding to FIG. 28C and FIG. 29C, gates 3602 and 3604 do not cover any of the apertures. This position maps to the Modified Release Dosage where the Nutrient Release Capsule releases all of its nutrient, faster than the plants can absorb, yielding an amplification of the nutrients.

For the embodiment of FIGS. 26-29C, user twists to open more perforations. The top view shows the water entering and the nutrients exiting as the water interacts with the capsule at the center of the chamber. The dotted line depicts the removable filter that catches undissolved materials.

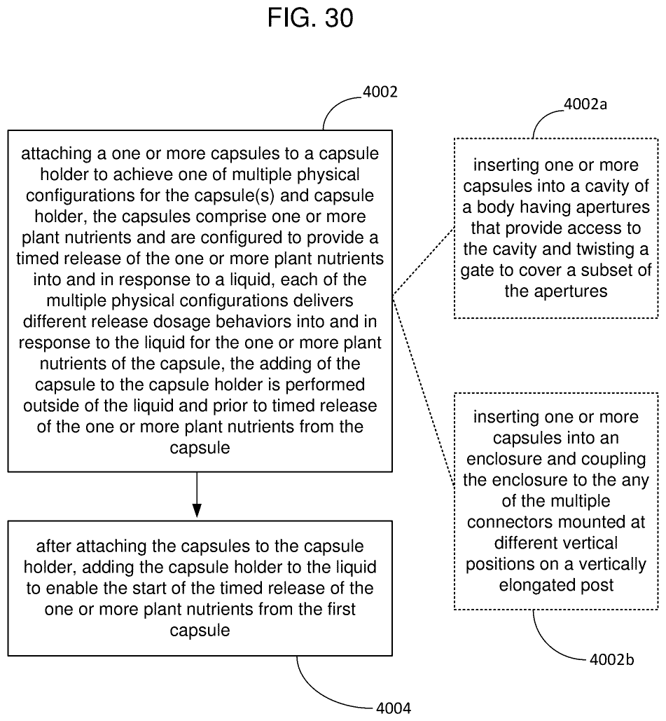

FIG. 30 is a flow chart describing one embodiment for operating the capsules and capsule holder discussed herein to provide nutrients to plants in the above-described hydroponic plant growing system. The process of FIG. 30 can be performed for any of the structures depicted in FIGS. 18-29C.

Step 4002 includes attaching a one or more capsules (e.g., capsule 3020) to a capsule holder (e.g., 3100 or 3502) to achieve one of multiple physical configurations for the capsule(s) and capsule holder. The capsules comprise one or more plant nutrients and are configured to provide a timed release of the one or more plant nutrients into and in response to a liquid. The release is said to be in response to the liquid because the coating for the nutrients is water soluble such that the nutrients are not released until the capsule is in contact with the liquid. Each of the multiple physical configurations (see e.g., positions A, B, C of FIG. 23 or Positions 1/2/3 of FIGS. 28A/B/C and 29A/B/C) delivers different release dosage behaviors (see modified release, sustained release, or diminishing release of FIG. 21) into and in response to the liquid for the one or more plant nutrients of the capsules. The adding of the capsule to the capsule holder is performed outside of the liquid and prior to timed release of the one or more plant nutrients from the capsules.

One example embodiment of step 4002 includes inserting the one or more capsules into an enclosure (e.g., 3101) and coupling the enclosure to any of multiple connectors (e.g., 3120-3130) mounted at different vertical positions on a vertically elongated post (e.g., 3302).

One example embodiment of step 4002 includes inserting one or more capsules into a cavity of a body having apertures that provide access to the cavity and twisting one or more gates (e.g., 3602/3604) to cover all or a subset of the apertures.

Step 4004 includes, after attaching the capsules to the capsule holder, adding the capsule holder to the liquid to enable the start of the timed release of the one or more plant nutrients from the first capsule.

In one embodiment, the process of FIG. 30 is performed in response to, or as part of, step 2208 of the process of FIG. 13 and/or step 2512 of the process of FIG. 14.

A more efficient and improved manner for providing nutrients to plants in a hydroponic (or other type of) plant growing system has been disclosed.

One embodiment includes an apparatus, comprising: a capsule comprising hydroponic plant fertilizer, the capsule configured to provide a timed release of the hydroponic plant fertilizer into and in response to a liquid; and a capsule holder configured to support the capsule, the capsule holder is configured to have multiple physical configurations each of which delivers different release dosage behaviors into and in response to the liquid for the hydroponic plant fertilizer.

In one example implementation, the capsule holder is configured to have three physical configurations including a first configuration for delivering an increasing rate of release of the hydroponic plant fertilizer from the capsule, a second configuration for delivering a constant rate of release of the hydroponic plant fertilizer from the capsule and a third configuration for delivering a decreasing rate of release of the hydroponic plant fertilizer from the capsule.

In one example implementation, the capsule holder is configured to be able to change configurations without being in contact with the liquid.

In one example implementation, the capsule comprises a powdered hydroponic fertilizer center with a biopolymer outer coating to slow release of the hydroponic plant fertilizer.

In one example implementation, the capsule comprises a capsule enclosure and capsule content; the capsule enclosure comprises a starch-based biopolymer derived from tapioca; and the capsule content comprises an array of pre-mixed and fully homogenized fertilizer salts that contain macro and micro nutrients with any one or more of the following contents: Iron, Zinc, Sulfur, Boron, Molybdate, Copper, Calcium, Phosphorus, Potassium, Manganese, and Magnesium.

In one example implementation, the capsule holder is configured to support multiple capsules that comprise hydroponic plant fertilizer.

In one example implementation, the capsule holder comprises an enclosure with apertures in the enclosure to allow for transmission of the liquid and a filter configured to filter the liquid flowing through the apertures.

In one example implementation, the capsule holder comprises an enclosure for housing the capsule and multiple connectors configured to be mounted at different vertical positions of a tank, the enclosure is configured to be coupled to the any of the connectors such that the enclosure can be positioned at different vertical positions of the tank.

In one example implementation, the enclosure is configured to be coupled to the any of the connectors such that the enclosure can be positioned at three different vertical positions of the tank including a first vertical position, a second vertical position and a third vertical position; and the capsule holder is configured to have three physical configurations including a first configuration corresponding to the enclosure being positioned at the first vertical position for delivering an increasing rate of release of the hydroponic plant fertilizer from the capsule, a second configuration corresponding to the enclosure being positioned at the second vertical position for delivering a constant rate of release of the hydroponic plant fertilizer from the capsule and a third configuration corresponding to the enclosure being positioned at the third vertical position for delivering a decreasing rate of release of the hydroponic plant fertilizer from the capsule.

In one example implementation, the capsule holder comprises: a vertically elongated post having a flange at a top end, the flange is configured to wrap around a top of a tank and removably support the post inside the tank; multiple connectors mounted at different vertical positions on the vertically elongated post; and an enclosure for housing the capsule, the enclosure including a connector configured to be coupled to the any of the multiple connectors mounted at different vertical positions on the vertically elongated post.

In one example implementation, the capsule holder comprises a body and a buoyant head attached to the top of the body, the body includes a cavity for housing the capsule.

In one example implementation, the body comprises a set of apertures that provide access to the cavity and a gate that can be moved to different positions that cover or expose different amounts of the apertures.

In one example implementation, the different positions comprise a first position, a second position and a third position; and the capsule holder is configured to have three physical configurations including a first configuration corresponding to the gate being at the first position for delivering an decreasing rate of release of the hydroponic plant fertilizer from the capsule, a second configuration corresponding to the gate being at the second position for delivering a constant rate of release of the hydroponic plant fertilizer from the capsule and a third configuration corresponding to the gate being at the third position for delivering an increasing rate of release of the hydroponic plant fertilizer from the capsule.

In one example implementation, the apparatus further includes (or is part of) a hydroponic plant growing system, the capsule holder is configured to fit in the hydroponic plant growing system.

In one example implementation, the hydroponic plant growing system comprises a water re-circulation system, the capsule holder is configured to fit in the water re-circulation system.

In one example implementation, the hydroponic plant growing system includes a liquid re-circulation system, comprising: a pump; a tank; and plumbing connected to the pump and tank, the plumbing is configured to carry the liquid from the tank to plants in the hydroponic plant growing system in response to the pump, the capsule holder is configured to fit in the tank.

In one example implementation, the capsule holder comprises an enclosure for housing the capsule and multiple connectors configured to be mounted at different vertical positions of the tank, the enclosure is configured to be coupled to the any of the connectors such that the enclosure can be positioned at different vertical positions of the tank.

In one example implementation, the hydroponic plant growing system includes: a plurality of trays, each of the trays having a floor with a drain opening and a second opening raised from a level of the floor, the floor having a main region configured for placement of plants and where the drain opening and the second opening are located in a region of the tray on a first side of the main region of the floor; a rack configured to hold the plurality of trays in vertical arrangement of the trays, including a top-most tray and a bottom-most tray; and a liquid re-circulation system, comprising: a pump; a tank; and plumbing. The plumbing includes: one or more auxiliary drainpipe segments configured, for each of trays except the bottom-most tray, to connect between the bottom of the second opening thereof and the top of the second opening of an underlying tray; a supply tube configured to be connected to the pump, routed up the auxiliary drainpipe segments and supply the top-most tray with liquid from the tank; and one or more drainpipe segments configured, for each of trays except the bottom-most tray, to connect to the bottom of the drain opening thereof to supply the underlying tray with liquid drained therefrom, the capsule holder is configured to fit in the tank.

In one example implementation, the apparatus further includes a plurality of tray lids configured to be placed over main region of one of the trays and each having one or more openings configured to hold a plant; and one of more net cups, each configured to fit into one of the tray lid openings and suspend a plant over an underlying tray.

In one example implementation, the apparatus further includes a software application that is configured to determine which configuration of the multiple physical configurations to implement at a given time for a current set of plants in the hydroponic plant growing system.

One embodiment includes an apparatus, comprising: a capsule comprising one or more plant nutrients, the capsule configured to provide a timed release of the one or more plant nutrients in response to a liquid; and means for causing different release dosage behaviors in response to the liquid for the one or more plant nutrients of the capsule. In some examples, the means for causing different release dosage behaviors can include the structures depicted in any of FIGS. 18, 20, 22, and 23-29C performing the process of FIG. 30.

One embodiment includes a method, comprising: attaching a first capsule to a capsule holder to achieve one of multiple physical configurations for the first capsule and capsule holder, the first capsule comprises one or more plant nutrients and is configured to provide a timed release of the one or more plant nutrients into and in response to a liquid, each of the multiple physical configurations delivers different release dosage behaviors into and in response to the liquid for the one or more plant nutrients of the capsule, the adding of the capsule to the capsule holder is performed outside of the liquid and prior to timed release of the one or more plant nutrients from the capsule; and after attaching the first capsule to the capsule holder, adding the capsule holder to the liquid to enable the start of the timed release of the one or more plant nutrients from the first capsule.

One example implementation further comprises: attaching additional capsules to the capsule holder, in conjunction with the attaching of the first capsule to the capsule holder, to achieve one of the multiple physical configurations, the adding the capsule holder to the liquid is performed with the capsule holder holding the additional capsules.

In one example implementation, the attaching the first capsule to the capsule holder to achieve one of multiple physical configurations comprises inserting the first capsule into a cavity of a body having apertures that provide access to the cavity and twisting a gate to cover a subset of the apertures.

In one example implementation, the attaching the first capsule to the capsule holder to achieve one of multiple physical configurations comprises inserting the first capsule into an enclosure and coupling the enclosure to any of multiple connectors mounted at different vertical positions on a vertically elongated post.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more other parts). In some cases, when an element is referred to as being connected or coupled to another element, the element may be directly connected to the other element or indirectly connected to the other element via one or more intervening elements. When an element is referred to as being directly connected to another element, then there are no intervening elements between the element and the other element. Two devices are “in communication” if they are directly or indirectly connected so that they can communicate electronic signals between them.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify different objects.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus, comprising:
a capsule comprising hydroponic plant fertilizer, the capsule configured to provide a timed release of the hydroponic plant fertilizer into and in response to a liquid; and
a capsule holder configured to support the capsule, the capsule holder is configured to have multiple physical configurations each of which delivers different release dosage behaviors into and in response to the liquid for the hydroponic plant fertilizer.

2. The apparatus of claim 1, wherein:
the capsule holder is configured to have three physical configurations including a first configuration for delivering an increasing rate of release of the hydroponic plant fertilizer from the capsule, a second configuration for delivering a constant rate of release of the hydroponic plant fertilizer from the capsule and a third configuration for delivering a decreasing rate of release of the hydroponic plant fertilizer from the capsule.

3. The apparatus of claim 1, wherein:
the capsule holder is configured to be able to change configurations without being in contact with the liquid.

4. The apparatus of claim 1, wherein:
the capsule comprises a powdered hydroponic fertilizer center with a biopolymer outer coating to slow release of the hydroponic plant fertilizer.

5. The apparatus of claim 1, wherein:
the capsule comprises a capsule enclosure and capsule content;
the capsule enclosure comprises a starch-based biopolymer derived from tapioca or other starch-based product; and
the capsule content comprises an array of pre-mixed and fully homogenized fertilizer salts that contain macro and micro nutrients with any one or more of the following contents: Iron, Zinc, Sulfur, Boron, Molybdate, Copper, Calcium, Phosphorus, Potassium, Manganese, and Magnesium.

6. The apparatus of claim 1, wherein:
the capsule holder is configured to support multiple capsules that comprise hydroponic plant fertilizer.

7. The apparatus of claim 1, wherein:
the capsule holder comprises an enclosure with apertures in the enclosure to allow for transmission of the liquid and a filter configured to filter the liquid flowing through the apertures.

8. The apparatus of claim 1, wherein:
the capsule holder comprises an enclosure for housing the capsule and multiple connectors configured to be mounted at different vertical positions of a tank, the enclosure is configured to be coupled to the any of the connectors such that the enclosure can be positioned at different vertical positions of the tank.

9. The apparatus of claim 8, wherein:
the enclosure is configured to be coupled to the any of the connectors such that the enclosure can be positioned at three different vertical positions of the tank including a first vertical position, a second vertical position and a third vertical position; and
the capsule holder is configured to have three physical configurations including a first configuration corresponding to the enclosure being positioned at the first vertical position for delivering an increasing rate of release of the hydroponic plant fertilizer from the capsule, a second configuration corresponding to the enclosure being positioned at the second vertical position for delivering a constant rate of release of the hydroponic plant fertilizer from the capsule and a third configuration corresponding to the enclosure being positioned at the third vertical position for delivering a decreasing rate of release of the hydroponic plant fertilizer from the capsule.

10. The apparatus of claim 1, wherein the capsule holder comprises:
a vertically elongated post having a flange at a top end, the flange is configured to wrap around a top of a tank and removably support the post inside the tank;
multiple connectors mounted at different vertical positions on the vertically elongated post; and
an enclosure for housing the capsule, the enclosure including a connector configured to be coupled to the any of the multiple connectors mounted at different vertical positions on the vertically elongated post.

11. The apparatus of claim 1, wherein:
the capsule holder comprises a body and a buoyant head attached to the top of the body, the body includes a cavity for housing the capsule.

12. The apparatus of claim 11, wherein:
the body comprises a set of apertures that provide access to the cavity and a gate that can be moved to different positions that cover or expose different amounts of the apertures.

13. The apparatus of claim 12, wherein:
the different positions comprise a first position, a second position and a third position; and
the capsule holder is configured to have three physical configurations including a first configuration corresponding to the gate being at the first position for delivering an decreasing rate of release of the hydroponic plant fertilizer from the capsule, a second configuration corresponding to the gate being at the second position for delivering a constant rate of release of the hydroponic plant fertilizer from the capsule and a third configuration corresponding to the gate being at the third position for delivering an increasing rate of release of the hydroponic plant fertilizer from the capsule.

14. The apparatus of claim 1, further comprising:
a hydroponic plant growing system, the capsule holder is configured to fit in the hydroponic plant growing system.

15. The apparatus of claim 14, wherein:
the hydroponic plant growing system comprises a water re-circulation system, the capsule holder is configured to fit in the water re-circulation system.

16. The apparatus of claim 14, wherein the hydroponic plant growing system includes a liquid re-circulation system, comprising:
a pump;
a tank; and
plumbing connected to the pump and tank, the plumbing is configured to carry the liquid from the tank to plants in the hydroponic plant growing system in response to the pump, the capsule holder is configured to fit in the tank.

17. The apparatus of claim 16, further comprising:
the capsule holder comprises an enclosure for housing the capsule and multiple connectors configured to be mounted at different vertical positions of the tank, the enclosure is configured to be coupled to the any of the connectors such that the enclosure can be positioned at different vertical positions of the tank.

18. The apparatus of claim 14, wherein the hydroponic plant growing system includes:
a plurality of trays, each of the trays having a floor with a drain opening and a second opening raised from a level of the floor, the floor having a main region configured for placement of plants and where the drain opening and the second opening are located in a region of the tray on a first side of the main region of the floor;
a rack configured to hold the plurality of trays in vertical arrangement of the trays, including a top-most tray and a bottom-most tray; and
a liquid re-circulation system, comprising:
a pump;
a tank; and
plumbing, including:
one or more auxiliary drainpipe segments configured, for each of trays except the bottom-most tray, to connect between the bottom of the second opening thereof and the top of the second opening of an underlying tray;
a supply tube configured to be connected to the pump, routed up the auxiliary drainpipe segments and supply the top-most tray with liquid from the tank; and
one or more drainpipe segments configured, for each of trays except the bottom-most tray, to connect to the bottom of the drain opening thereof to supply the underlying tray with liquid drained therefrom, the capsule holder is configured to fit in the tank.

19. The apparatus of claim 18, further comprising:
a plurality of tray lids configured to be placed over main region of one of the trays and each having one or more openings configured to hold a plant; and
one of more net cups, each configured to fit into one of the tray lid openings and suspend a plant over an underlying tray.

20. The apparatus of claim 14, further comprising:
a software application that is configured to determine which configuration of the multiple physical configurations to implement at a given time for a current set of plants in the hydroponic plant growing system.

21. An apparatus, comprising:
a capsule comprising one or more plant nutrients, the capsule configured to provide a timed release of the one or more plant nutrients in response to a liquid; and
means for causing different release dosage behaviors in response to the liquid for the one or more plant nutrients of the capsule.

22. A method, comprising:
attaching a first capsule to a capsule holder to achieve one of multiple physical configurations for the first capsule and capsule holder, the first capsule comprises one or more plant nutrients and is configured to provide a timed release of the one or more plant nutrients into and in response to a liquid, each of the multiple physical configurations delivers different release dosage behaviors into and in response to the liquid for the one or more plant nutrients of the capsule, the adding of the capsule to the capsule holder is performed outside of the liquid and prior to timed release of the one or more plant nutrients from the capsule; and
after attaching the first capsule to the capsule holder, adding the capsule holder to the liquid to enable the start of the timed release of the one or more plant nutrients from the first capsule.

23. The method of claim 22, further comprising:
attaching additional capsules to the capsule holder, in conjunction with the attaching of the first capsule to the capsule holder, to achieve one of the multiple physical configurations, the adding the capsule holder to the liquid is performed with the capsule holder holding the additional capsules.

24. The method of claim 22, wherein:
the attaching the first capsule to the capsule holder to achieve one of multiple physical configurations comprises inserting the first capsule into a cavity of a body having apertures that provide access to the cavity and twisting a gate to cover a subset of the apertures.

25. The method of claim 22, wherein:
the attaching the first capsule to the capsule holder to achieve one of multiple physical configurations comprises inserting the first capsule into an enclosure and coupling the enclosure to any of multiple connectors mounted at different vertical positions on a vertically elongated post.
